(19) United States
(12) Patent Application Publication
(10) Pub. No.: US 2026/0110241 A1
(43) Pub. Date: Apr. 23, 2026

(54) IMPLEMENTATION OF GENERATIVE ARTIFICIAL INTELLIGENCE IN OILFIELD OPERATIONS

(71) Applicant: SCHLUMBERGER TECHNOLOGY CORPORATION, Sugar Land, TX (US)

(72) Inventor: Jerome MASSOT, Menlo Park, CA (US)

(21) Appl. No.: 19/153,058

(22) PCT Filed: May 24, 2024
(86) PCT No.: PCT/US2024/031108

§ 371 Date: Aug. 1, 2025

Related U.S. Application Data
(60) Provisional application No. 63/504,278, filed on May 25, 2023.

(51) Int. Cl. E21B 43/16

(52) U.S. Cl. CPC E21B 43/16; E21B 2200/20; E21B 2200/22

(57) ABSTRACT

A method for monitoring a risk to a stability of a wellbore in a subsurface formation includes receiving first input data 2024/243558 representing the wellbore or the subsurface formation. The method also includes extracting parameter-value pairs from the first input data. The method also includes determining an expected pore pressure gradient based upon the parameter-value pairs. The method also includes determining an expected fracture gradient based upon the parameter-value pairs. The method also includes determining a mud weight uncertainty profile for the wellbore based upon the expected pore pressure gradient and the expected fracture gradient.

### CROSS-REFERENCE TO RELATED APPLICATIONS

This application claims priority to U.S. Provisional Ser. No. 63/504,278 , filed on May 25, 2023, which is incorporated by reference herein in its entirety.

### BACKGROUND

Oilfield operations may generally involve leveraging large amounts of data to make effective and efficient decisions for exploration, drilling, completion, production, or any other phase of the well construction and/or operation process. The large amounts of data are often reviewed and analyzed manually, which can be a time consuming and error-prone process. Recently, artificial intelligence, such as natural language models and generative language models, have been implemented that can be taught to search, analyze, and condense such large data stores and return specific, useful information (e.g., in response to prompts or queries). What is needed is an improved system and method for processing large amounts of data.

### SUMMARY

A method for monitoring a risk to a stability of a wellbore in a subsurface formation is disclosed. The method includes receiving first input data representing the wellbore or the subsurface formation. The method also includes extracting parameter-value pairs from the first input data. The method also includes determining an expected pore pressure gradient based upon the parameter-value pairs. The method also includes determining an expected fracture gradient based upon the parameter-value pairs. The method also includes determining a mud weight uncertainty profile for the wellbore based upon the expected pore pressure gradient and the expected fracture gradient.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving first input data. The first input data includes texts, tables, and priors representing a subsurface formation. The first input data is captured or received prior to drilling a wellbore in a subsurface formation. The operations also include extracting parameter-value pairs from the first input data. The operations also include determining an expected pore pressure gradient based upon the parameter-value pairs. The operations also include determining an expected fracture gradient based upon the parameter-value pairs. The operations also include determining a mud weight uncertainty profile for the wellbore based upon the expected pore pressure gradient and the expected fracture gradient. The operations also include receiving second input data representing the subsurface formation or the wellbore. The second input data is captured or received after drilling of the wellbore has begun. The second input data includes pressure measurements and leak-off tests (LOTs). The operations also include updating the expected pore pressure gradient based upon the second input data to produce an updated pore pressure gradient. The expected pore pressure gradient is updated based upon the pressure measurements. The operations also include updating the expected fracture gradient based upon the second input data to produce an updated fracture gradient. The expected fracture gradient is updated based upon the LOTs. The operations also include comparing the updated pore pressure gradient and the updated fracture gradient to the mud weight uncertainty profile. The operations also include determining that the updated pore pressure gradient or the updated fracture gradient is within a predetermined threshold of the mud weight uncertainty profile, which indicates a possible risk to a stability of the wellbore.

A computer program is also disclosed. The computer program includes instructions that, when executed by a computer processor of a computing device, causes the computing device to perform operations. The operations include receiving first input data. The first input data includes texts, tables, and priors representing a subsurface formation. The first input data is captured or received prior to drilling a wellbore in a subsurface formation. The operations also include extracting parameter-value pairs from the first input data. The parameter-value pairs are extracted using a large language model (LLM). The parameter-value pairs include parameters and corresponding values. The parameters are measured by a measurement-while-drilling (MWD) tool in the wellbore, a logging-while-drilling (LWD) tool in the wellbore, or a sensor at the surface above the wellbore. The parameters include location, temperature, pressure, vibration, permeability, porosity, viscosity, stress, strain, or flow rate. The values include numerical values of the parameters. The values include numerical values of the parameters. The operations also include determining an expected pore pressure gradient based upon the parameter-value pairs. The expected pore pressure gradient is determined using a statistical learning plug-in or agent. The operations also include determining an expected fracture gradient based upon the parameter-value pairs. The expected fracture gradient is determined using the statistical learning plug-in or agent. The operations also include determining a mud weight uncertainty profile for the wellbore based upon the expected pore pressure gradient and the expected fracture gradient. The mud weight uncertainty profile is determined using the statistical learning plug-in or agent. The operations also include receiving second input data representing the subsurface formation or the wellbore. The second input data is captured or received after drilling of the wellbore has begun. The second input data includes pressure measurements and leak-off tests (LOTs). The operations also include updating the expected pore pressure gradient based upon the second input data to produce an updated pore pressure gradient. The expected pore pressure gradient is updated based upon the pressure measurements. The expected pore pressure gradient is updated using the LLM and the statistical learning plug-in or agent. The operations also include updating the expected fracture gradient based upon the second input data to produce an updated fracture gradient. The expected fracture gradient is updated based upon the LOTs. The expected fracture gradient is updated using the LLM and the statistical learning plug-in or agent. The operations also include comparing the updated pore pressure gradient and the updated fracture gradient to the mud weight uncertainty profile. The comparison is performed by an anomaly detector plug-in or agent. The operations also include determining that the updated pore pressure gradient or the updated fracture gradient is within a predetermined threshold of the mud weight uncertainty profile, which indicates a possible risk to a stability of the wellbore. The determination is performed by the anomaly detector plug-in or agent. The operations also include displaying the expected pore pressure gradient, the expected fracture gradient, the mud weight uncertainty profile, the updated pore pressure gradient, and the updated fracture gradient.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a condensed prompt instructing a large language model (LLM) to create statistical representations from text/table content and to detect possible anomalies using plug-ins/agents, according to an embodiment.

FIGS. 5A and 5B illustrate statistical representation learning from text contents and priors using a LLM and a plug-in/agent, according to an embodiment.

FIG. 6 illustrates an evolution of the prompt modified by the LLM and the plug-in/agent during the construction of the statistical representations of parameters from text contents, according to an embodiment.

FIGS. 7A and 7B illustrate examples of input materials used to extract the knowledge for calculating pre-drilling gradients and a mud weight profile, according to an embodiment.

FIGS. 8A and 8B illustrate a workflow combining LLM, statistical learner plug-in/agent and anomaly detector plug-in/agent applied during drilling operations, according to an embodiment.

FIG. 9 illustrates a LLM instructed by prompt augmented by several agents provides efficient L1 customer support, according to an embodiment.

FIG. 10 illustrates a schematic pipeline using a retriever plug-in/agent ranking contextualized knowledge relevant to customer's question, according to an embodiment.

FIG. 11 illustrates a schematic pipeline using the FAQ plug-in/agent ranking FAQ content relevant to customer's question for direct answering or/and confidence scoring of an answer generated by a LLM, according to an embodiment.

FIG. 12 illustrates a schematic pipeline showing an agent building a customer representation from support history and metadata and decoding it as context for prompt augmentation, according to an embodiment.

FIGS. 13A and 13B illustrate an overview of the workflow pipeline with simplified technological bricks, according to an embodiment.

FIG. 14 illustrates a block diagram of a workflow, according to an embodiment.

FIG. 15 illustrates a dashboard for displaying the knowledge extracted using the workflow, according to an embodiment.

FIG. 16 illustrates several examples of common content corruption during an OCR process, according to an embodiment.

FIG. 17 illustrates a condensed augmented prompt instructing the LLM to understand, clean, and reformat the information embedded into a corrupted OCRed text, according to an embodiment.

FIGS. 18A and 18B illustrate examples of data drift between the technical document layouts and the page layout used for training and consolidating conventional OCR engines, according to an embodiment.

FIG. 19 illustrates a condensed augmented prompt that uses language understanding and language generation abilities of a LLM to extract and serve knowledge from corrupted OCRed text, according to an embodiment.

FIG. 20 illustrates keyword matching-based search engine process, according to an embodiment.

FIG. 21 illustrates a retriever-reader architecture used by an answering engine, according to an embodiment.

FIG. 22 illustrates a condensed augmented prompt including full information content, according to an embodiment.

FIG. 23 illustrates a condensed augmented prompt including an agent, according to an embodiment.

FIG. 24 illustrates data curation using generative LLM prompting, according to an embodiment.

FIG. 25 illustrates several possible applications of form auto-completion, data curation, and data serving, according to an embodiment.

FIG. 26 illustrates a computing system for performing at least a portion of the method(s) disclosed herein, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding. However, it will be apparent to one of ordinary skill in the art that the embodiments described in the detailed description may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the disclosure. The first object and the second object are both objects, respectively, but they are not to be considered the same object.

The terminology used in the description herein is for the purpose of describing particular embodiments only and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining”or “in response to detecting,”depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

### System Overview

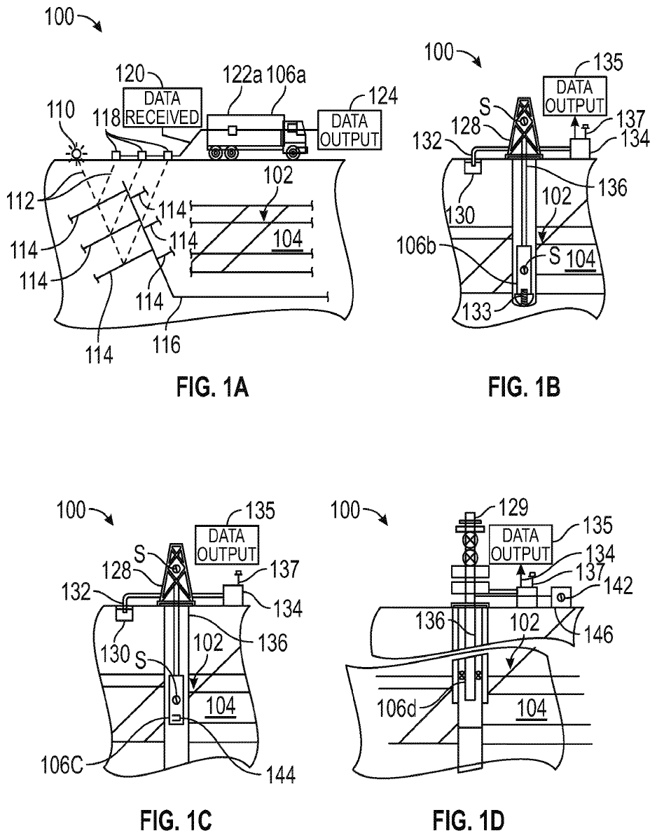

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real-time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors (S), such as gauges, may be positioned about oilfield 100 to collect data relating to various field operations as described previously. As shown, the sensor(S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

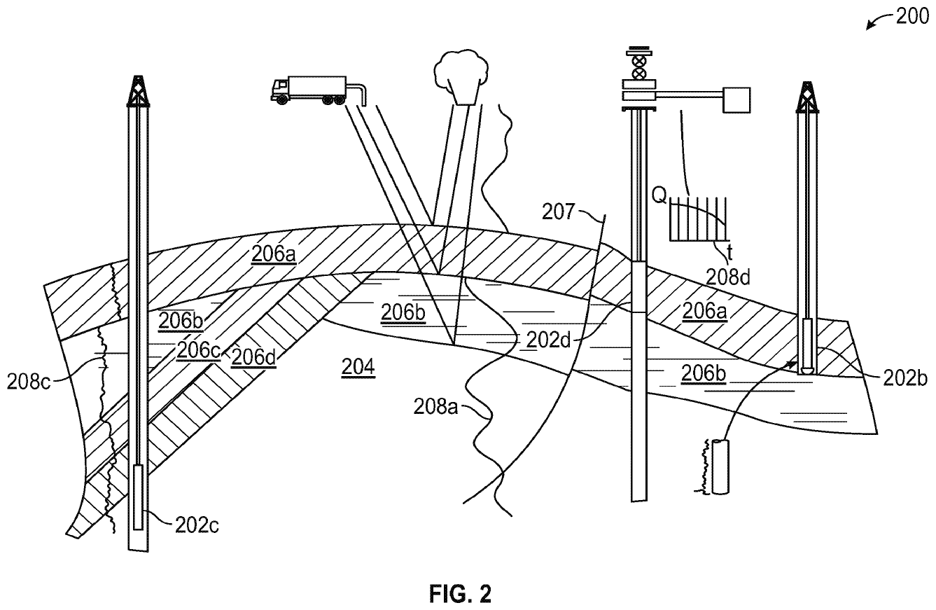

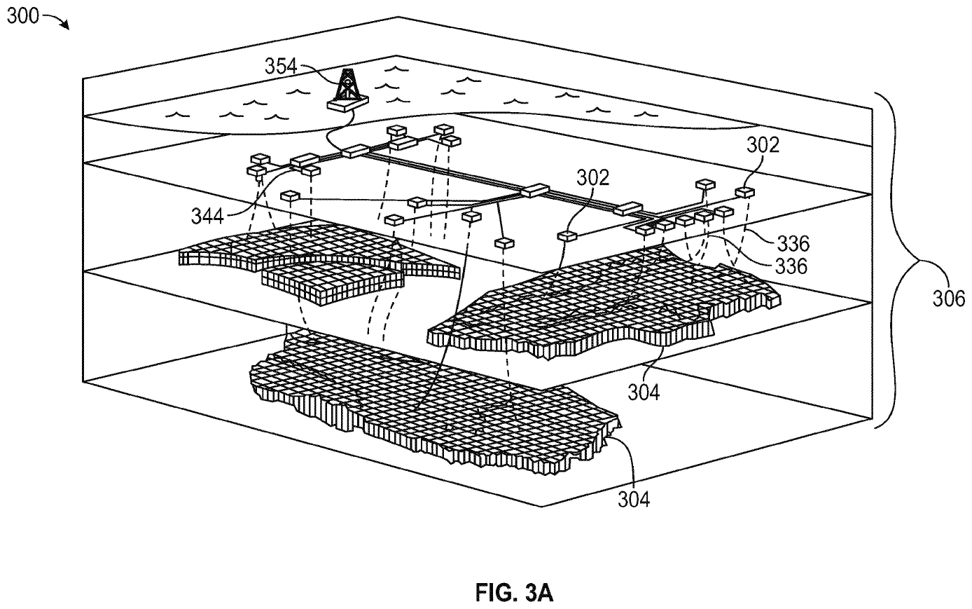

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analyzed using modeling techniques.

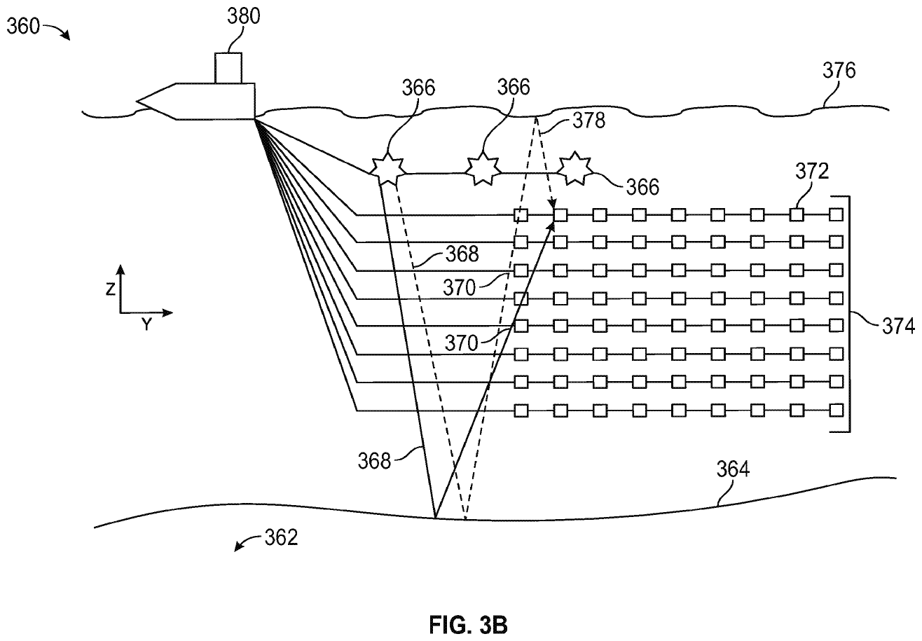

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

### 1. Use of augmented prompt technique associated to Large Language Models and Plug-in/Agents to create efficient statistical learner and anomalies detector

A large amount of numerical data is reported on a daily or weekly basis in an unstructured format, mainly in reports and technical documents. The numerical information can be embedded into the text content or inserted in the reports as individual tables. There can be a long delay between the report publication and the ingestion of the numerical data into a database or a spreadsheet, using a more structured format. Further, statistical analysis of this numerical data may be done from the structured format and not with the original source. Accordingly, there is a potential delay between the moment that the numerical information is published and the time when it is analyzed with statistical methods. This delay can be consequential when the statistical analysis identifies anomalies.

Embodiments of the disclosure use a Large Language Model (LLM) assisted by several specific plug-ins/agents to perform a statistical analysis of numerical data and anomaly detection directly from an unstructured format, e.g., from text content and table data embedded in original reports and technical documents. Augmented prompts instruct the LLM about the tasks to be completed and the plug-ins/agents to be used. As a result, the model may be integrated in existing or new industrial workflows more easily than other software solutions built on the conventional numerical analysis tools plugged on databases or other structured format sources.

Embodiments of the disclosure include a combination of a specific pipeline orchestrated by an augmented prompt instructing the LLM and a collection of plug-ins/agents responsible for the statistical analysis and anomaly detection.

The LLM is responsible for understanding the text content, its vocabulary, and its articulation. The ability of the LLM for natural text understanding (NTU) enables the possibility of extracting automatically from text (e.g., unstructured data), without specific additional fine-tuning, the numerical content as pairs of (parameter, value) linking parameters to corresponding values. The same NTU ability allows the LLM to extract the same (parameter, value) pairs from the tables embedded in the documents content (semi-structured data).

A statistical learner plug-in/agent oversees analyzing the (parameter, value) pairs extracted by the LLM for constructing statistical representations of the data. These may be parameter distributions or correlations between parameters. These statistical representations can be constrained by a priori models (“priors”) or specific constraints (e.g., such as a minimum and/or a maximum values).

An anomaly detector plug-in/agent may use statistical representations made by the first agent or previously generated elsewhere to detect any anomaly in the (parameter, value) pairs extracted by the LLM from the text content and the embedded tables. In the case of a detected anomaly, the agent instructs the LLM to generate an adequate output to the user, for example, by querying an anomalies-origins-resolutions database and proposing a consistent protocol to identify the possible origins of the detected anomaly and how to resolve it. This workflow may be orchestrated by a single augmented prompt ingested by the LLM at the beginning of the process.

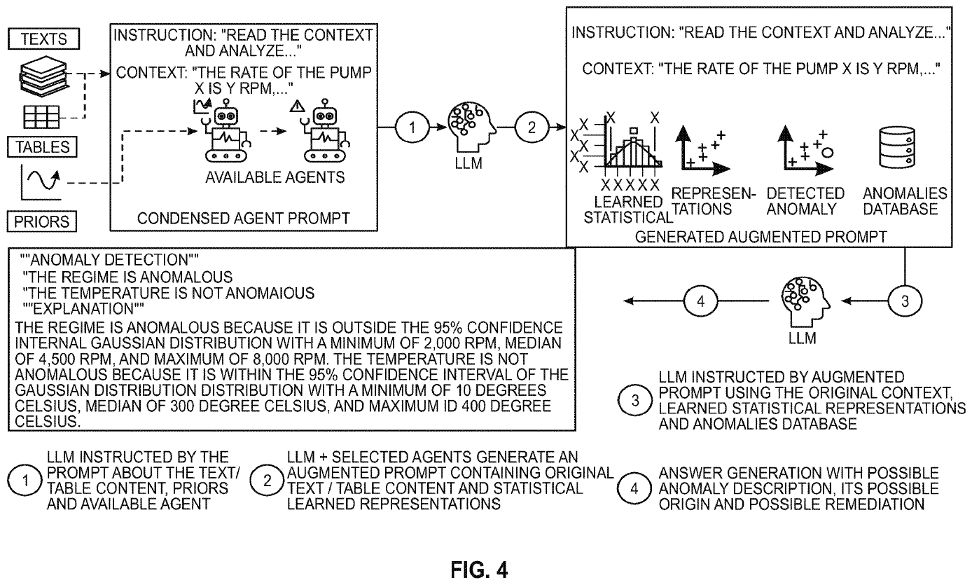

FIG. 4 illustrates a condensed prompt instructing the LLM to create statistical representations from text/table content and to detect possible anomalies using plug-ins/agents, according to an embodiment. If an anomaly is detected, the LLM can return possible origin and remediation using an external database.

Two example use cases are now presented. In the first example, the statistical learner plug-in/agent is used to create statistical representations of petrophysical characteristics of geological formations, extracted from vintage reports. In the second example, redaction and use of daily drilling reports manipulated in field operations is conducted using two plug-ins/agents for statistical representations updates and anomalies detection.

Use-Case 1: When no structured source of information is available or accessible, it is common to see geoscientists parsing many reports of different vintage and origin to reconstruct the characteristics of geological formations. Embodiments of the disclosure may automate this process by using a LLM and the statistical learner plug-in/agent in charge of creating the geological characteristics statistical representations.

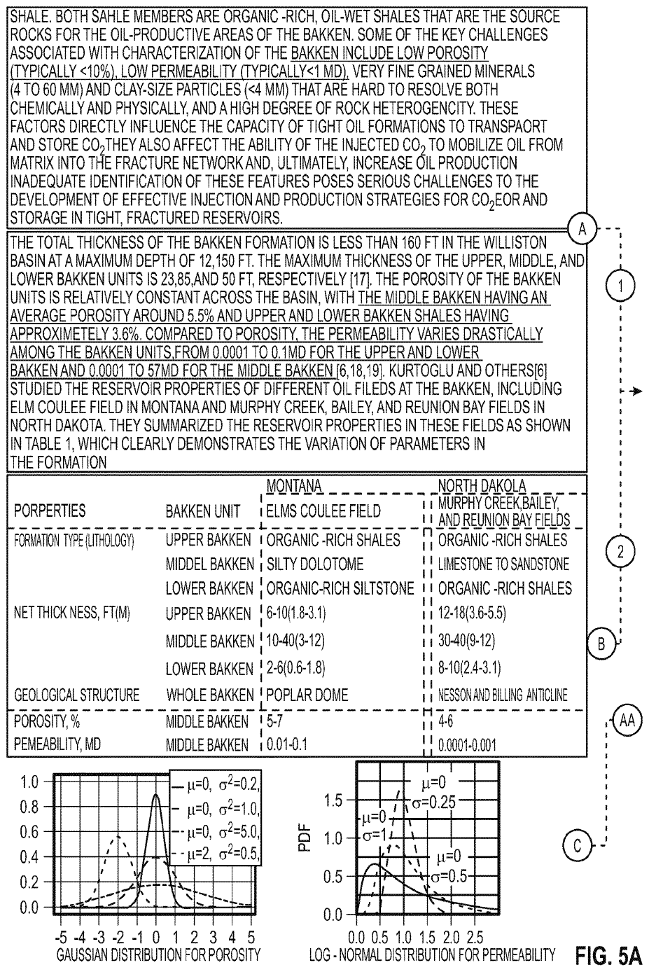

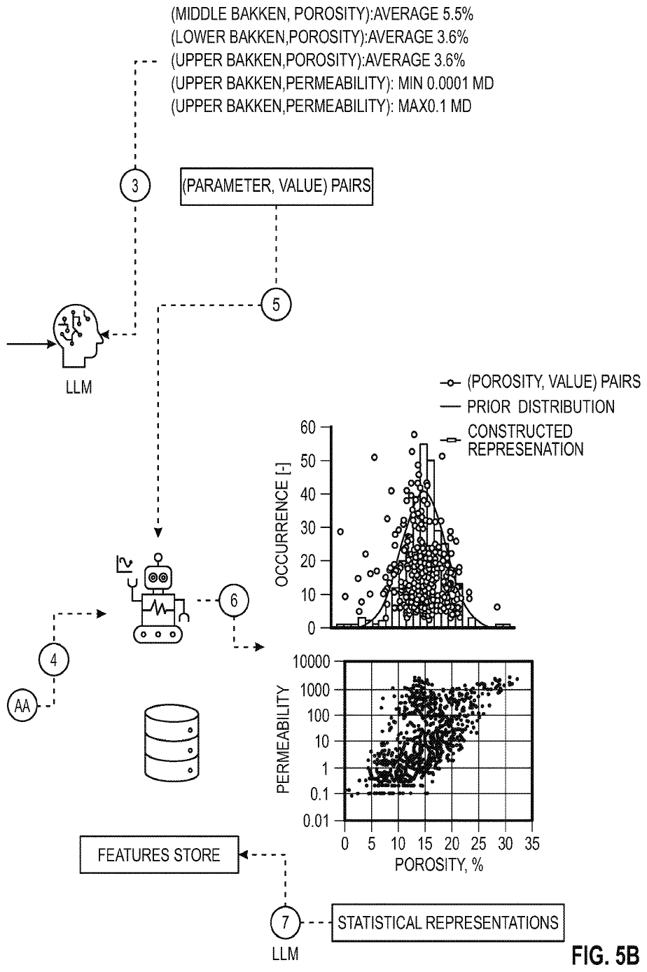

FIGS. 5A and 5B illustrate statistical representation learning from text contents and priors using a LLM and a plug-in/agent (e.g., as part of use case 1), according to an embodiment.

The LLM “reads” the text contents from the reports (worksteps 1 and 2 in FIG. 5A) and extracts the (parameter, value) pairs for each identified geological formation (workstep 3 in FIG. 5B). The pairs can be found in the texts (A in FIG. 5A) and the tables embedded in the reports (B in FIG. 5). It is a direct benefit of the natural language understanding ability of the LLM.

Once these (parameter, value) pairs have been collected from the report, they are ingested by the statistical learner plug-in/agent (workstep 5 in FIG. 5B) which oversees the statistical analysis builds the corresponding mathematical representations (workstep 6 in FIG. 5B). Univariate analysis creates the parameter distributions, and bivariate analysis calculates correlations between the identified parameters. During this statistical analysis process, the plug-in/agent can be constrained by priors (workstep 4 in FIG. 5B) given by geoscientists, such as particular distribution models (e.g., a Gaussian model for the porosity parameter and a log-normal model for the permeability parameter).

The statistical representations are stored in a features store which promotes the consistency and the shareability of the learned statistical representations. The ingestion of this data in the store is automated using the LLM, which automatically generates the scripts for performing this operation (workstep 7 in FIG. 5B). No code is anticipated here as the LLM generates the scripts on-demand, fitting the parameters identified from the text contents. It is a direct benefit of the natural language generation ability of the LLM.

This pipeline is created and orchestrated by a prompt, e.g., a text written in plain human language which instructs the language model and the plug-in/agent about the operations to be performed and how to interact during the process. The prompt nature and content evolve at each point in the workflow/pipeline. The prompt is first in its condensed state, then is enriched to an augmented state and eventually ends as an output prompt.

Prompts can contain these different components. For example, the instructions describe with much detail how the language model and the plug-in/agent should treat the enriched data, named context. This instruction can be several pages long, but can be summarized as: “Acting as a statistical analysis tool, extract the pairs of parameter and value for each geological formation found in the text contents and create the corresponding statistical representations using these pairs and the given external constraints . . . ”. This instruction may be used in the condensed and the output worksteps.

The initial prompt, in its condensed form, includes the links to the text contents to be analyzed and possible priors or other constraints defined by geoscientists. These constraints/priors can be expressed in plain language or refer to existing objects stored in a feature store for example. The language model combines the extracted pairs of (parameter, value) with these priors/constraints to form the enriched context of the augmented context used by the plug-in/agent for its statistical work. These statistical representations of the parameters are used as the final context embedded in the output prompt which also includes the initial instruction and an output parser. This parser ensures that the statistical representations learned by the plug/agent are reformulated by the language model as a script that is used to populate the selected feature store.

Use-Case 2: Embodiments of the disclosure can be used for the parsing and the enrichment of daily well drilling reports. A daily well drilling report is a document that is used to track the progress of a drilling operation. It contains information about the drilling activity such as: the depth of the hole, the pressures measured during drilling, the type of drill bit used, the type and density of the mud used to ease the drilling and ensure the hole stability, the amount of time spent drilling, the amount of material removed, and any problems encountered. It also includes information about the safety of the operation, such as the number of personnel on site, the type of safety equipment used, and any safety incidents that occurred. The report is used to monitor the progress of the drilling operation and to ensure that it is being conducted safely and efficiently.

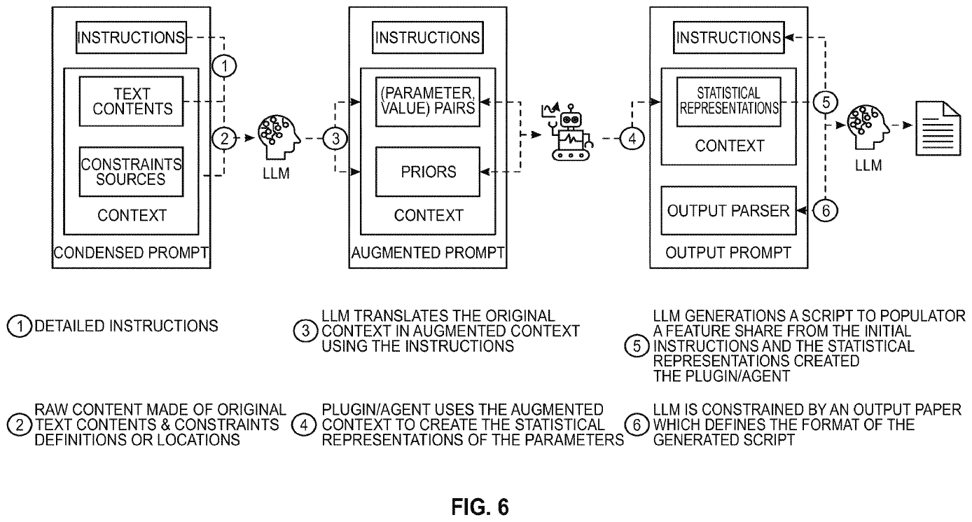

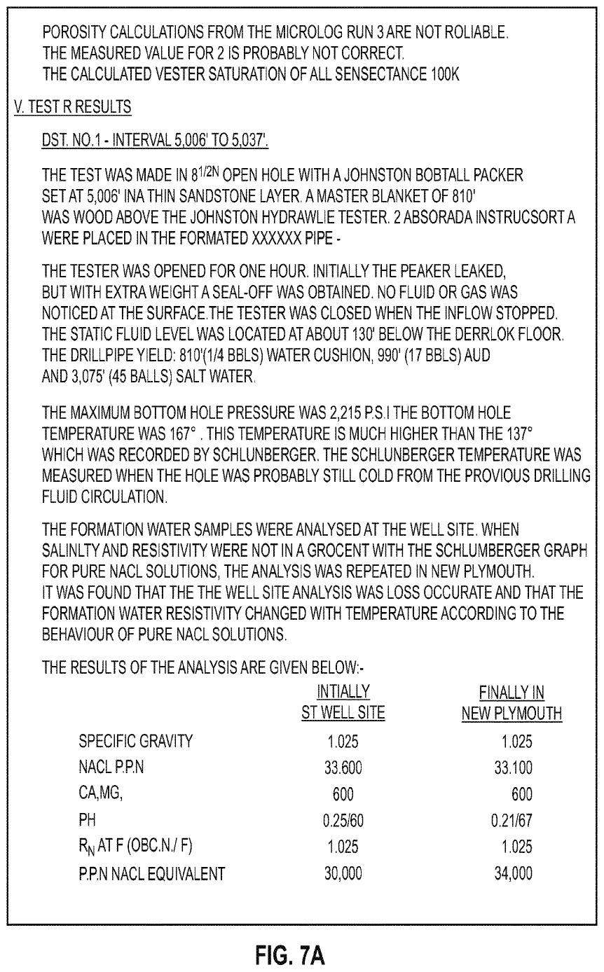

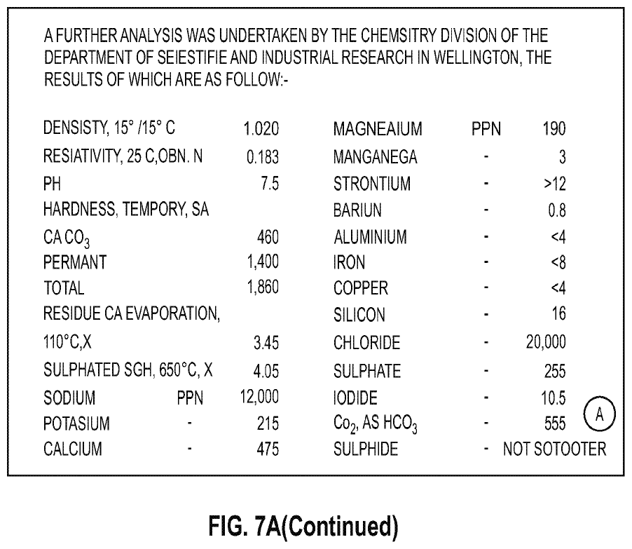

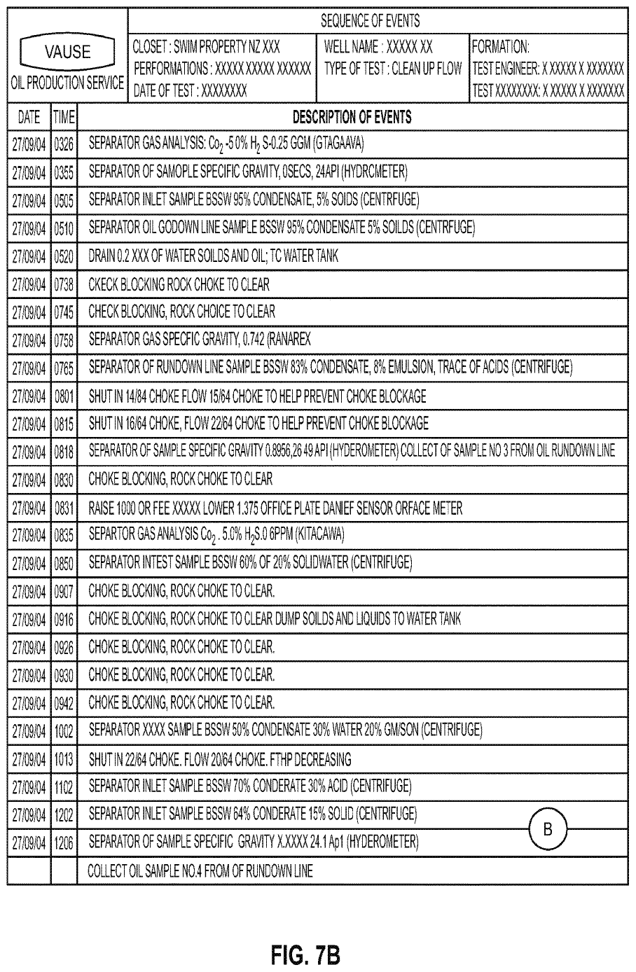

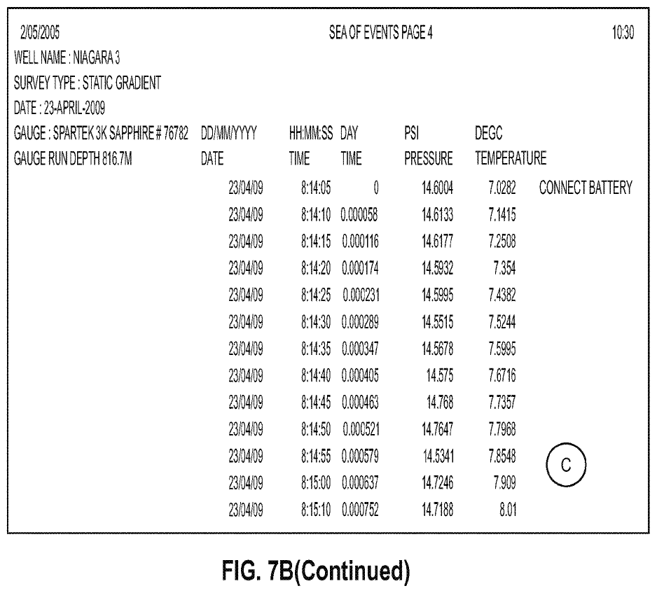

FIG. 6 illustrates an evolution of the prompt modified by the LLM and the plug-in/agent during the construction of the statistical representations of parameters from text contents, according to an embodiment. FIGS. 7A and 7B illustrates examples of input materials used to extract the knowledge for calculating pre-drilling gradients and the mud weight profile, according to an embodiment. LLM language understanding ability and plug-in/agent are involved in this process, according to an embodiment.

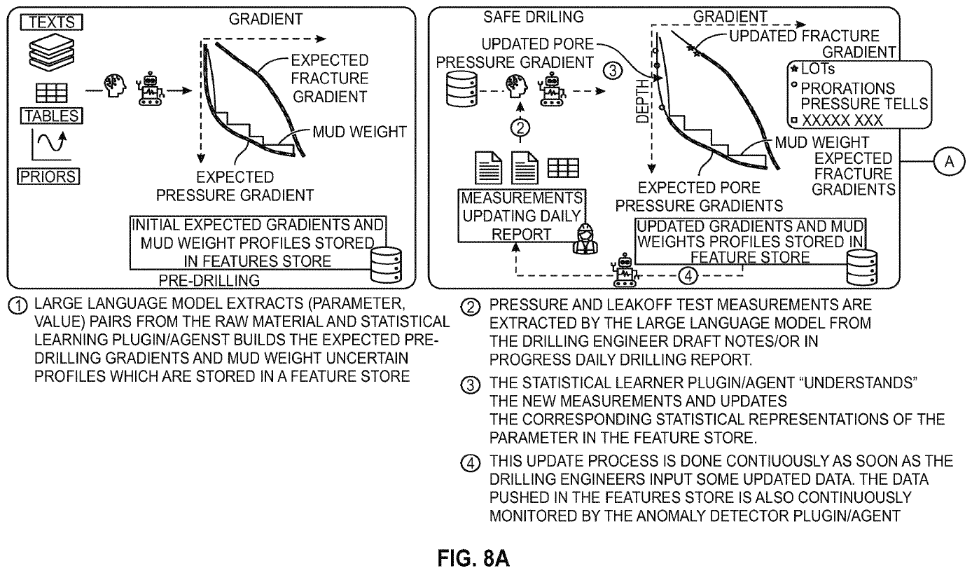

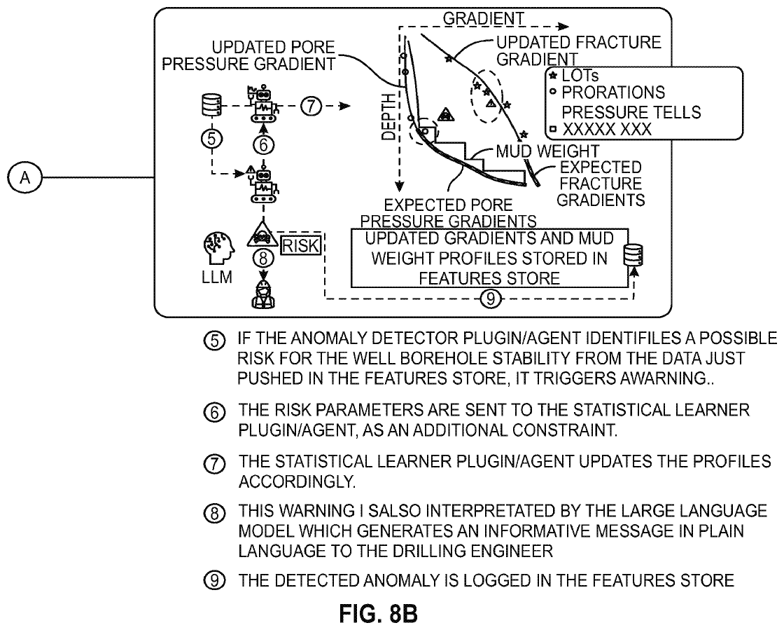

FIGS. 8A and 8B illustrate a workflow combining the LLM, a statistical learner plug-in/agent, and an anomaly detector plug-in/agent applied during drilling operations, according to an embodiment. Monitoring the formation pore pressure gradient, the fracture gradient, and the mud weight during drilling are among several parameters reported in the daily document, and assist in monitoring for drilling success and safety. As illustrated in FIG. 6, the pore pressure gradient is the expected evolution of the pressure with depth, the fracture gradient is the pressure to break the rocks around the well, and the mud weight has to be between the pore pressure gradient and the fracture gradient for safe drilling.

Before drilling, the pore pressure gradient and the fracture gradient may be estimated by analogy with similar wells and/or by analyzing different kinds of geological and geophysical data (pre-drilling phase in FIG. 8, workstep 1). These expected gradients, despite being uncertain, are used to predict a mud weight profile for the new well. Both the expected gradient profiles and the associated uncertainties are reported in the new drilling report. As shown in FIG. 7, the past wells drilling reports and other geosciences documents contain text and semi-formatted content (tables). The extraction of the information from these documents and the calculation of the expected gradients curves and associated uncertainties can be done by the LLM associated to the statistical learner plug-in/agent. These statistical representations can be stored in a features store. This may correspond to the Use-Case 1, discussed above.

During the drilling operations, the anticipated profiles are reevaluated in the new well, using pressure measurements done for the pore pressure gradient and by doing leak-off tests (LOTs) for the fracture gradient. These measurements are saved in draft notes or directly inserted in the in-progress daily report by the drilling engineer (FIG. 8, workstep 2). The LLM and the statistical learner plug-in/agent use the new information to update the gradient profiles in real-time, in replacement of specialized software (FIG. 8, workstep 3). The pipeline is like the one introduced in the first use-case, but it ingests streaming data, extracted from the draft notes or the in-progress report, overseeing the statistical representations updates continuously (by Gaussian fitting or other mathematical process). These updated gradients keep the features store up to date (FIG. 8, workstep 4), feature store which can be used as a trustable source of data for other software.

The possibility to update continuously the reference curves from draft notes or in-progress reporting permits to use another plug-in/agent responsible of detecting any shift from expected profiles and the associated risk. This anomaly detector plug-in/agent compares, in real-time, the updated reference gradients curves stored the features store, and the predicted mud weight curve (FIG. 8, workstep 5). If the current or future mud weight is too close to the updated pore pressure gradient or the fracture gradient, the anomaly detector plug-in/agent feedbacks the LLM which generates a warning in plain language (FIG. 8, workstep 8), that can be sent to the drilling engineer directly in the reporting tool using the auto-completion functionality for example. In parallel, the system can mitigate the risk by proposing an update for the mud weight profile, thanks to the statistical learner plug-in/agent capacity (FIG. 8, workstep 7) informed by the anomaly detector plug-in/agent (FIG. 8, workstep 6). Again, the LLM encodes these updates as convenient scripts for features store automatic updates. The anomalies and possible remediation solutions are also logged into the features store the same way (FIG. 8, workstep 9).

The workflow covering pressure gradients monitoring and mud density updates during drilling may seem familiar to the people involved in the drilling engineering activities, mainly because it replicates the typical processes validated by the SMEs for years. But the main difference here is that the pre-drilling analysis and the drilling monitoring are done with a simple technological stack made of a LLM and two plug-ins/agents. Transferring data in different formats back and forth multiple specialized software may be avoided. Training on complex software to interact with the workflow orchestrator may also be avoided, as the human-machine interaction is done in plain human language.

For numerous complex technological stacks combining proprietary software, it is possible to replace them by a single LLMs assisted by dedicated plug-ins/agents, interacting with users using human languages. Beyond the geosciences and drilling engineering perimeters, any application extracting data from unstructured source (such as reports, articles, slides, emails, etc.) and transforming it into enriched knowledge, tracking any potential anomaly or error, can benefit from this method.

Embodiments of the present disclosure may provide simplicity, as the technological process is controlled and articulated by single instructions (organized as a prompt) written in plain human language. Knowledge of scripting/programming language may not be a prerequisite. Further, successful prompts may already be available, previously validated by prompt engineering specialists before the tool is deployed.

Further, embodiments may be flexible and may adapt existing prompts to a particular situation. Modifying an instruction may be done with human language. Anyone can test the prompts just by rewording the instructions to the LLM. This may also apply to the plug-ins/agents, which individually oversee a limited number of tasks, and then are easier to adapt than a large monolithic software, depending on the situation.

Embodiments may be understandable beyond English-spoken audience. Prompting is not limited to a single language (usually English) as LLMs are multi-lingual. Similarly, as the LLMs can generate texts in several human languages. Thus, complexities associated with tool regionalization may be avoided. The generalization is done de-facto by the natural language generative capacity of the LLMs.

Embodiments may condense power. The natural language model ability to understand complex data is surprisingly high, better than the humans for many tasks. Combined with well-chosen plug-ins/agents, the technical stack offers performance level equivalent or even higher than the existing technologies, for a smaller footprint.

Embodiments may enforce workflow efficiency. More particularly, embodiments may facilitate setup and use by avoiding deploying a complex interleaved collection of heavy software and transferring data from one software to another, wasting time in format conversion and system switch. The data flows may be managed automatically by transparent interactions between the LLM and the light modular plug-ins/agents.

Embodiments may also be cost effective. By using a pre-trained and fine-tuned LLM and several light plug-in/agents, the cost of at least some embodiments may be less than the traditional stack combining multiple vendors and licenses.

Accordingly, embodiments include the deployment of LLMs associated to plug-ins/agents in replacement of the existing deprecated and heavy technological industrial ecosystems.

### 2. Use of Generative Large Language Model and a Collection of Plug-Ins/Agents for L1 Customer Support Applications

L1 support is the first level of customer support for a product or service. It may involve providing basic troubleshooting and technical assistance to customers. This may include providing help with installation, setup, configuration, and other basic issues. It can be extended to the basic usage of the equipment or the software. L1 support may be provided by customer service representatives or technicians who are trained to answer basic questions and provide basic solutions.

A generative large language model associated with a collection of plug-ins/agents can provide efficient L1 support to customers by allowing the plug-in/agent to generate complex natural language responses to customer inquiries. The large language model can be trained on a large corpus of customer support data. The plug-ins/agents are conceived for orchestrating the problem resolution workflow using possible interactions with the customers.

A generative LLM associated to a plug-in/agent can provide efficient L1 support to customers by allowing the plug-in/agent to generate natural language responses to customer inquiries. First, the prompt-instructed LLM can be trained on a large corpus of customer support data, such as customer inquiries and responses and technical documentation, to learn the patterns of language used in customer support conversations. The process of fine-tuning the model may be done by combining prompts (i.e., instruction) engineering and model alignment using human feedback.

The aligned LLM and engineered prompts allow external plug-ins/agents connected to the model to find knowledge and generate natural language responses that are tailored to the customer's specific inquiry or/and support history. This orchestrated pipeline is trigged by a single condensed prompt and provides accurate and efficient L1 support. Additionally, a plug-in/agent can detect the most common customer inquiries, allowing it to populate automatically a useful frequently asked questions collection which can accelerate the ticket resolution without the need for human intervention.

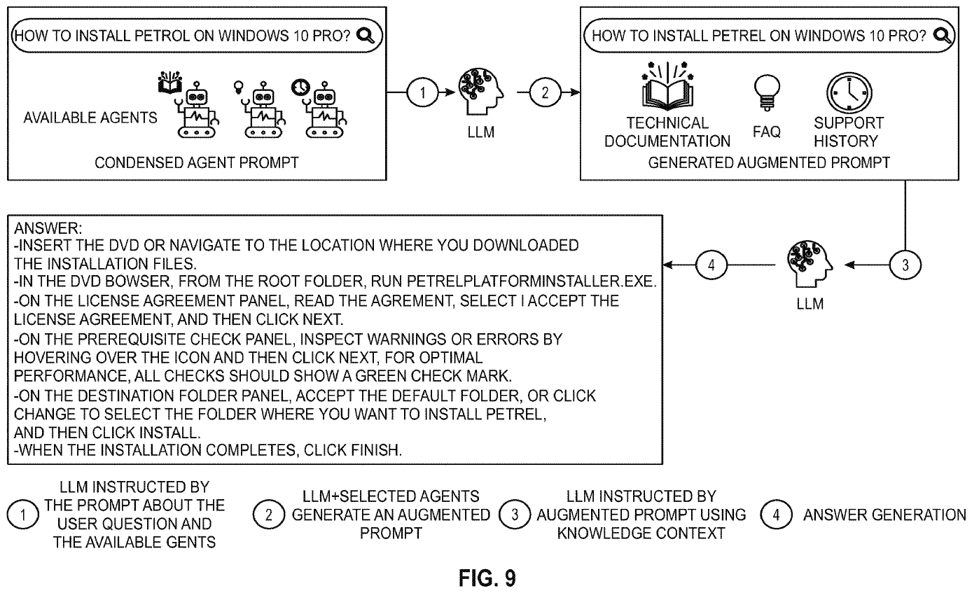

FIG. 9 illustrates a LLM instructed by prompt augmented by several agents provides efficient L1 customer support, according to an embodiment. For example, a customer, who in the past has already contacted a L1 support service, may re-send a question related to the installation of a specific piece of software in a specific configuration.

As background, the conventional way a customer question is answered by a L1 support service may proceed as follows.

Case A: the support representative does not understand the question. The question is transferred to another colleague. And/or the support representative sends a question back to the customer.

Case B: the support representative does understand the question but has no personal knowledge to answer it. More problematic, the representative cannot find an identified knowledge base. The question may be transmitted to another colleague.

Case C: the support representative understands the question and knows where information can be found to answer it. Knowledge base(s) can be of different natures (technical manuals, frequently asked questions repository, past questions-answers database).

The support representative searches the knowledge base(s) for articulating an answer. The answer is sent back to the customer.

Case D: the support representative understands the question and answers it using personal knowledge. The answer is sent back to the customer.

Except for the last scenario, where the answer is provided using the personal knowledge of the support service representative, each other cases have associated challenges.

Case A: it is a case of challenging natural language understanding. The support service representative cannot understand the user's question. It could be a problem of vocabulary (technical jargon) or/and a challenge associated with the question articulation or even language.

Case B: it is a case of challenging identification/access to relevant information permitting to articulate an answer. It could be because no knowledge material exists or because this materiel exists but cannot be identified.

Case C: Eventually, the knowledge material is known and used, but information to answer the question is not found. The common reason is the lack of contextualization of the tools used to search the information. When the knowledge material is made of PDF files, web pages or relational databases, the localizing information is performed by searching keywords overlapping the customer's question. This approach is ineffective as identified keywords are often confusing when considered out of context. For example, the search of the keywords “Windows” from the illustrative example may return flooding information about the software user interface which can be ranked with high prevalence, and little information about the Windows operating system, possibly ranked with low prevalence. A combination of the LLM and the plug-ins/agents may thus be employed to facilitate this process.

A challenge of natural language understanding is tackled by the usage of large language models(s), which can be aligned (by fine-tuning) to the technical topics expected by a L1 support platform. When a model has been exposed to a well-chosen selection of knowledge sources and a large collection of questions asked by customers, and the associated answers, it embeds in its internal language representation (its weights) the capacity of understanding technical language, at least as well as humans.

The challenge of finding the relevant knowledge base(s) may be handled by a plug-in/agent whose responsibility is to “understand” the customer's question, thanks to its relationship with the LLM attached to it, and to locate the knowledge base(s) containing the information needed to create an answer. Updating a plug-in/agent with a new collection of knowledge base (new reports, new web pages, new databases) is easier than retraining a team of support representatives about the new sources of information.

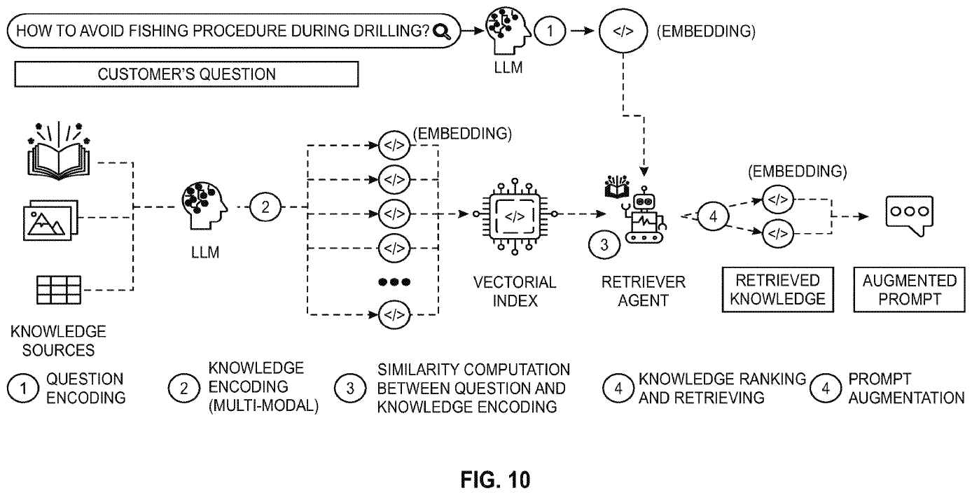

FIG. 10 illustrates a schematic pipeline using a retriever plug-in/agent ranking contextualized knowledge relevant to customer's question, according to an embodiment. The challenge of browsing the information in knowledge base(s) may be tackled by another in/agent whose responsibility is to retrieve the contexts (chunks of information) ranked in relation to the customer's question. The search and ranking of the relevant information may not be done by using keywords but by using the overlapping existing between the topics discussed in the customer's question and the topics mentioned in the knowledge base(s).

These topics are contextualized by the LLM in both the question and the knowledge base(s) thanks to specific language representations (called embeddings) created by the large language model. To compute the overlapping between the question and the knowledge base(s) content efficiently, the method uses an index containing the knowledge base(s) content embeddings. The plug-in/agent retrieves the more relevant information used to build an answer to the question by computing the similarities between the question embedding and the embeddings contained in the index. To keep the same example as used previously, the plug-in/agent here retrieves the information where the words ‘Windows’ refers to an operating system, as it has “understood” that in the context of the customer, this word does not refer to an element of the software user interface.

Eventually, the LLM generates an answer to the customer's question, from the knowledge embeddings retrieved from the index. The answer may not be extracted from the original content but generated using the natural language generation ability of the large language model.

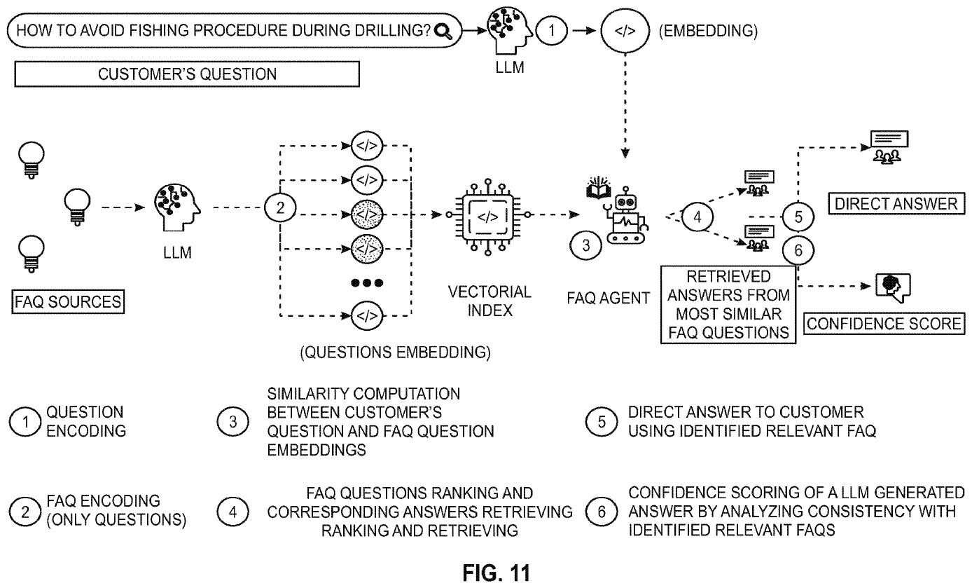

FIG. 11 illustrates a schematic pipeline using the FAQ plug-in/agent ranking FAQ content relevant to customer's question for direct answering or/and confidence scoring of a answer generated by a LLM, according to an embodiment. Additionally, more context can be given by at least two more plug-ins/agents. For example, an FAQ agent can retrieve curated knowledge from a frequently asked questions repository, using the same question embeddings overlapping mechanism. In this case, the questions of the FAQ are encoded and ingested by an index for future comparison with customers'queries. As customers often ask for the same questions, this plug-in/agent may accelerate the issue resolution by returning the FAQ information directly and/or increase the confidence score of the generated answer by comparing it with validated answers corresponding to most similar frequently asked questions.

A history and metadata agent can use the metadata associated to the customer and the support history (i.e., the past interactions existing with the customer). The metadata can identify their department, role and/or company, respecting the legal constraints. This information can be stored in a relational database or a vectorial index for example. The agent may combine these different sources of information to build a customer representation and send it as an additional context to the LLM. This is another example of contextualization made by a plug-in/agent permitting a more relevant answer.

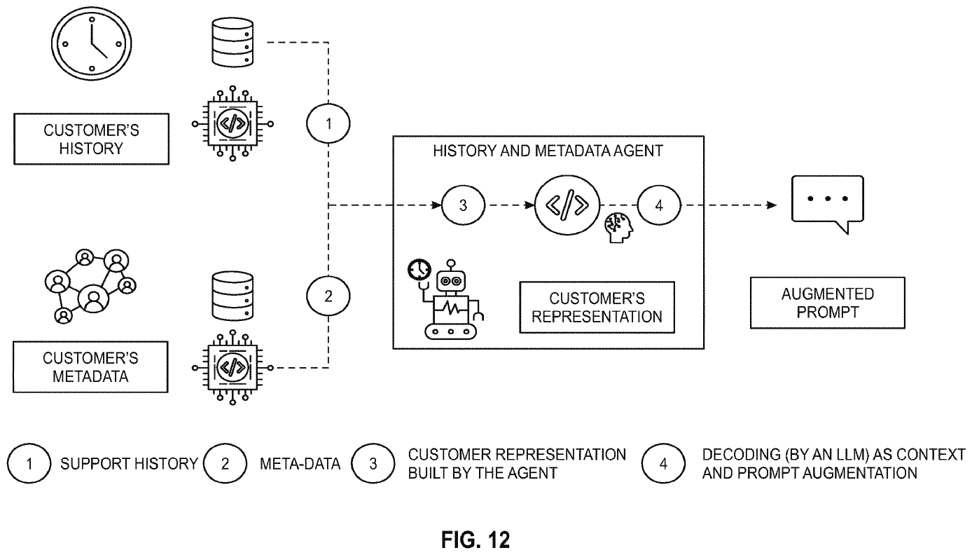

FIG. 12 illustrates a schematic pipeline showing an agent building a customer representation from support history and metadata and decoding it as context for prompt augmentation, according to an embodiment. This workflow may be triggered and orchestrated with a single instruction (prompt) sent to the large language model. The pipeline may be condensed in single instruction written in plain human language. No specific skill may be called for on the support team side.

L1 customer support platforms may benefit from embodiments disclosed herein, as such embodiments may solve common challenges associated with knowledge retrieval. Further, the embodiments may be easily implemented through the use of condensed prompt(s) enriched by plug-ins/agents, instructing a LLM with generative ability. This may increase flexibility and heighten “cognitive” capacity. Additionally, some embodiments can handle more complex questions, providing an efficient support higher than for the L1 level.

### 3. Video Transcript Enrichment With Speech to Text, Natural Language Processing and Machine Neural Translation Using Large Language Models

Today, an increasing proportion of the information and knowledge is available on video contents, rather than paper media. Automatic solutions may be provided for reviewing and extracting relevant information from this proliferation of video content. For example, solutions may serve a summarized report based on the videos'transcripts. This summarized content should capture the business and technical knowledge as a subject matter expert does. Beyond knowledge extraction and summarization from videos transcripts, natural language processing and machine neural translation offer today the possibility to enrich the original content for example by serving the information in other languages than the original one. Embodiments of the present disclosure include both the technologies and the workflow to extract, enrich, and serve the knowledge extracted from videos contents.

Embodiments may extract the transcript of any video (audio stream to text content) and to enrich this transcript with named entities recognition, summarization and automatic translation. The transcription of the video audio stream is the first operation completed by the proposed workflow. This may be done in two distinct worksteps. The first one is relative to the extraction of the audio stream from the video file. The second step is the transcription stricto-senso producing a text from the extracted audio data. The first workstep may be omitted if the ingested data is the audio file directly.

Once the text content has been extracted, the contained knowledge is extracted using natural language processing techniques such as named entities recognition, sentiment analysis, key-sentence extraction. Here, the business and technical content is both extracted and analyzed for producing valuable condensed information which is saved in an appropriate database or data warehouse. The original condensed information may be enriched by attaching other AI-engine techniques such as machine neural translation which automatically translates it in various target languages. The enriched condensed knowledge may then be provided to the human user. An interactive dashboard may be used, permitting data visual narrative and filtering capacity. The created dashboards can be deployed on-premises or in the cloud as web applications.

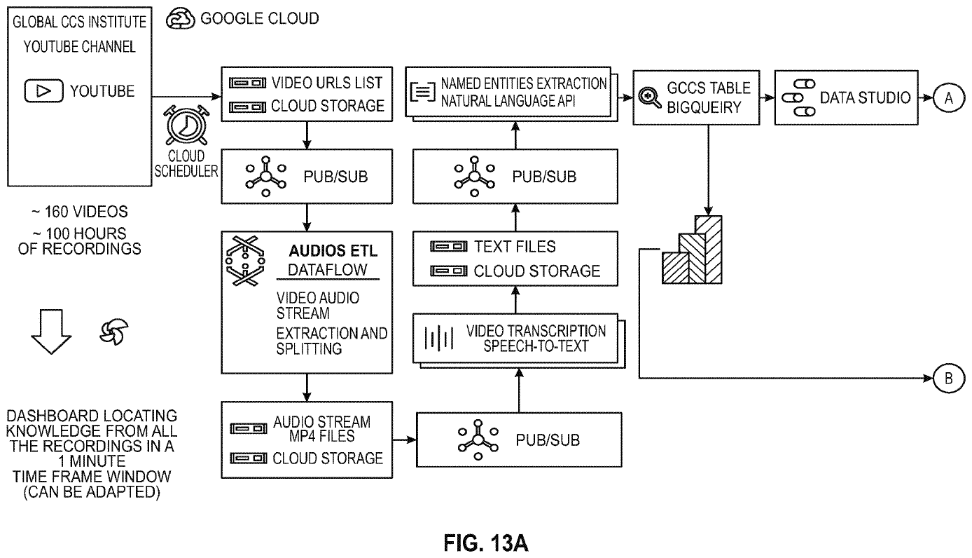

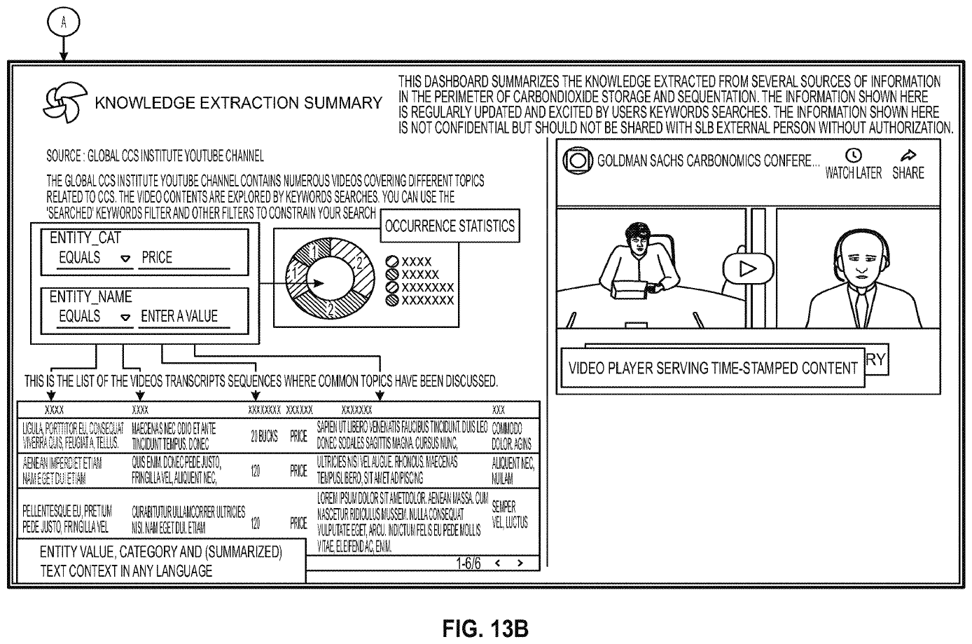

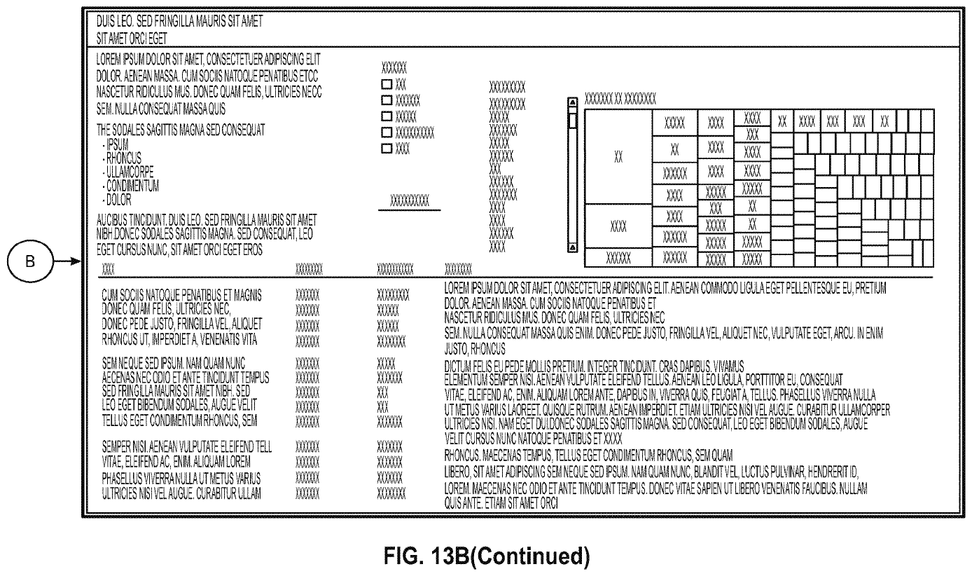

FIGS. 13A and 13B illustrate an overview of the workflow pipeline with simplified technological bricks, according to an embodiment. At least some embodiments may be employed for online web events where important information is shared about competition and customers. These web events are online events that consume a lot of time to attend the entire event when a few minutes of it bring the real business value. Embodiments of the disclosure permit the computer to follow the streaming event, ensure the transcription of the content, analyze this content, and extract valuable information which is served in an interactive dashboard, in the original or additional languages spoken at the event.

Similarly, when seeking information for projects development (e.g., analyzing the industrial cost of these projects), many of the sources of information found on the web are now provided as videos. Often, a few minutes of highly valuable information are dispersed in the full-length videos, forcing the audience to watch the entire videos to extract these tiny minutes of knowledge. Embodiments may extract the information from these videos automatically, to analyze this information and store the enriched knowledge in a knowledge base that can be used to feed dashboards or as knowledge graph backbone.

Training videos are another potential use-case for this automated workflow. Corporations may store a large collection of videos covering technical training. It is challenging to search the videos content with precision as the information needed is locked inside the videos. To better enrich the meta-data or to map precisely the technical contents of these videos, the Training team has to watch them from end-to-end. Embodiments may extract, analyze, and map in a time-stamped knowledge base, the content of the numerous videos, which may facilitate searching the videos content more precisely.

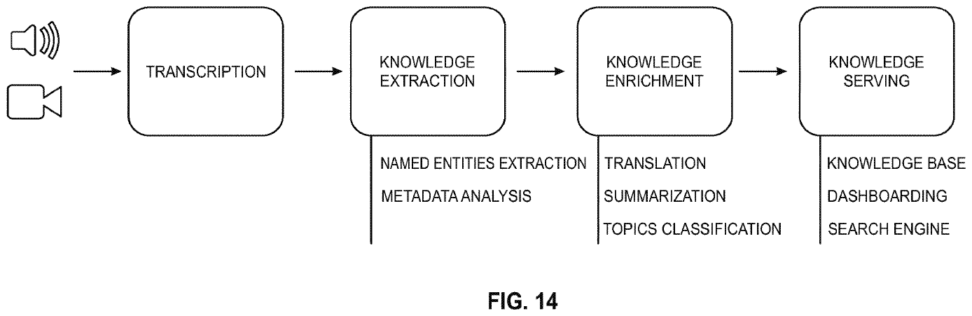

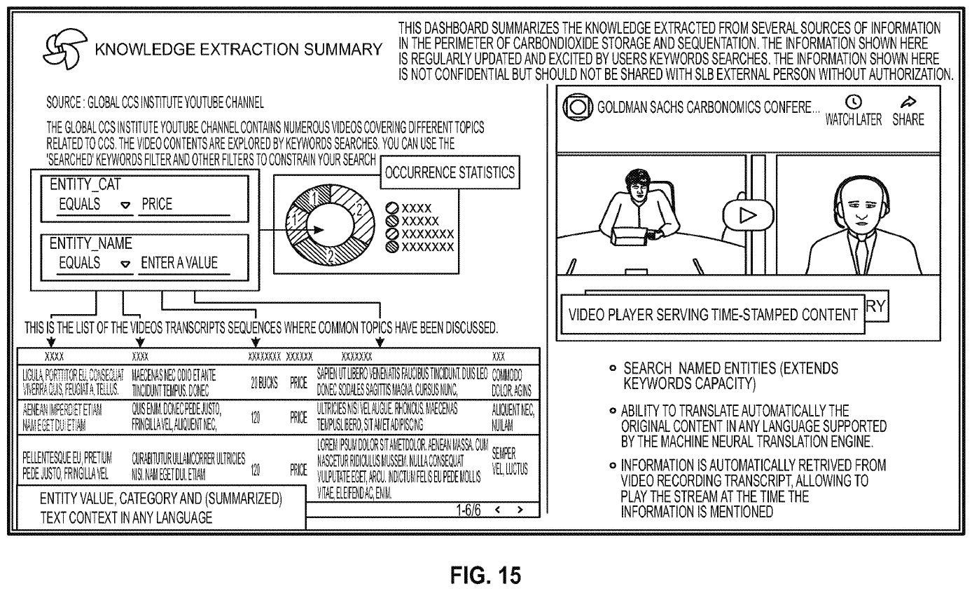

FIG. 14 illustrates a block diagram of a workflow, and FIG. 15 illustrates a dashboard for displaying the knowledge extracted using the workflow, according to an embodiment.

### 4. Use of Generative Large Language Models for OCR post-processing

OCR (Optical Character Recognition) may be used for extracting information from printed reports. OCR allows computers to quickly and accurately scan printed documents and convert them into digital text. This makes it easier to store, search, and share information from printed reports. OCR also makes it easier to access and use information from printed reports in other applications, such as databases and spreadsheets. In addition, OCR makes it easier to extract data from printed reports for use in data analysis.

Major progress has been accomplished in the last 20 years, mainly due to deep learning. However, it can be difficult for OCR to accurately recognize text in complex layout documents. This is because complex layout documents contain a variety of elements such as tables, columns, and graphics that can confuse the OCR software. Additionally, complex layout documents often contain fonts that are not standard and can be difficult for OCR to recognize. Finally, the layout of complex.

Embodiments of the present disclosure may use LLMs for post-processing OCR results to increase the quality of the text recognition. The natural language understanding and the natural language generation capabilities of the LLMs enable the understanding of noisy OCRed texts and its modification to produce cleaner texts.

The noisy OCR result may be made of text which has been corrupted during the recognition process. Several types of corruption can be distinguished: characters may have been wrongly recognized, entire words could have been substituted or inversed (e.g., due to failing rules-based or AI-based post-processing), several continuous words may have been merged, and/or contiguous sentences may have been merged into a single text sequence. These corruptions may happen often when structural content is embedded in the text, more precisely tables and figures legends.

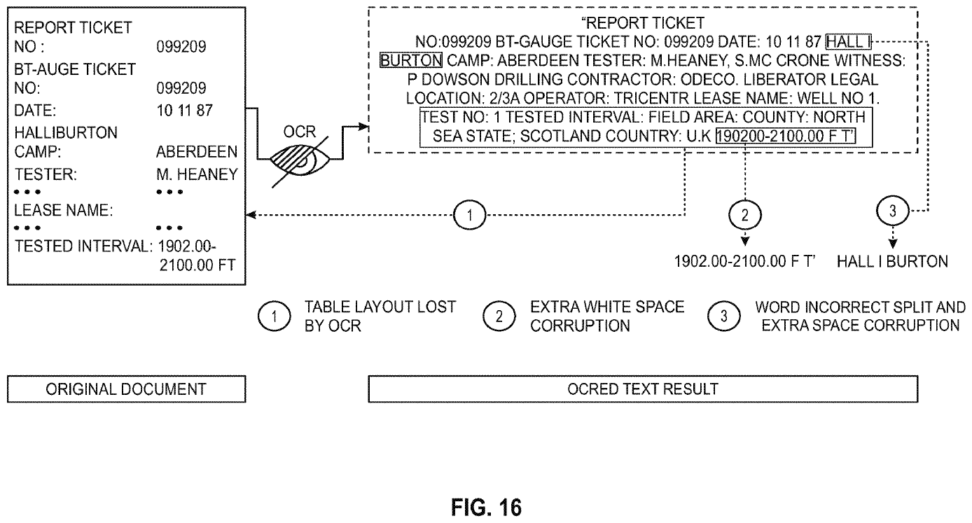

FIG. 16 illustrates several examples of common content corruption during OCR process, according to an embodiment. Embodiments of the present disclosure may use the natural language understanding and the natural language generation capabilities of the large language models to fix the corrupted OCRed content. The natural language understanding capacity of a LLM is used to ingest the corrupted OCRed content and seize its meaning. The ability of a LLM to understand different semantic styles, even corrupted ones, has been trained when the model has been exposed to a sufficient number of documents and text contents including tables, figures, complex document layouts.

The natural language generative capacity of a LLM is used to generate a text gathering the content extracted and fixed from the OCRed text. The generative capacity allows to clear the corruptions and to reformat the output content following the user's instructions. Embodiments of the disclosure may thus increase rapid content understanding. The correction and reformatting are done thanks to a condensed augmented prompt that instructs, in simple terms, the LLM how to proceed. The process may be managed directly by the internal machinery of the LLM following a simple prompt including instructions and possibly a context, written in plain human language. After treatment by the LLM, the original corrupted OCRed text is transformed into a more consistent content following a specific format (text, table, bullet points list,.) specified by users.

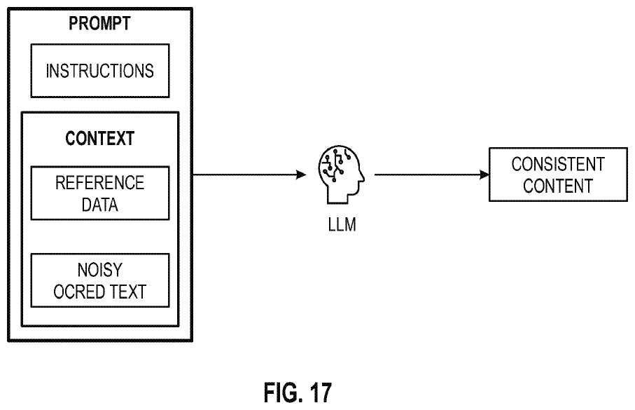

FIG. 17 illustrates a condensed augmented prompt instructs the LLM to understand, clean, and reformat the information embedded into a corrupted OCRed text, according to an embodiment. Conventional OCR solutions use a combination of rules, heuristics, and deep learning to correct recognition errors. Rules are pre-defined conditions that are used to detect and correct errors in the recognition process. Heuristics are algorithms that use pattern recognition to identify potential errors in the recognition process. Finally, deep learning is used to analyze the input data and detect patterns that can be used to identify and correct errors. This combination of rules, heuristics, and deep learning allows OCR solutions to identify and correct errors in the recognition process if a similar document as the document to be processed has been seen when the heuristics/rules have been created or during the training process if deep learning techniques are used. For any document showing a font, a layout or even a content that has not been seen before by the OCR engine, these conventional post-processing techniques could fail.

For example, well drilling reports correspond to a common family of documents used in the oil and gas industry, which may be “unfamiliar” to the general OCR engines (e.g., the OCR engines have not been trained for well drilling reports). Well-drilling reports usually blend paragraphs of texts (themselves included into tables), technical schemas, tables with complex layouts. These documents are challenging for an OCR engine trained on newspapers articles or fiction books, because they look, strictly speaking, different and because the technical content “sounds” different.

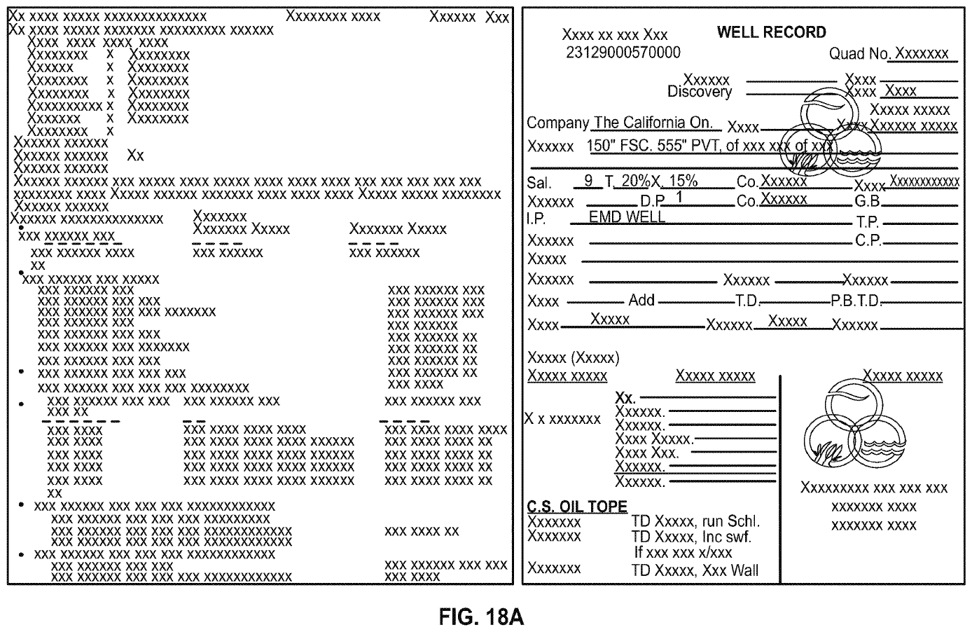

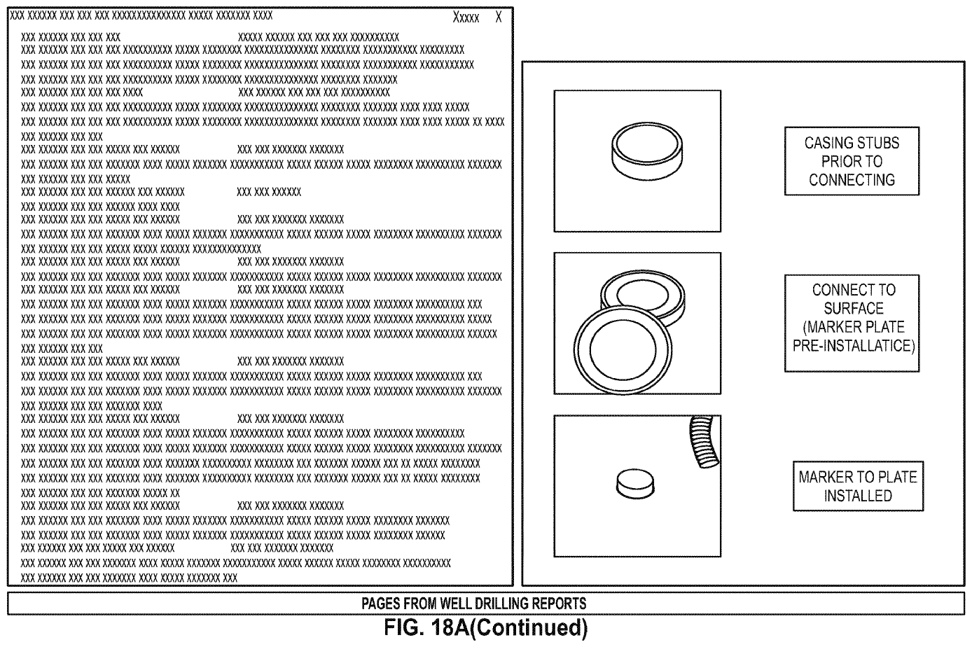

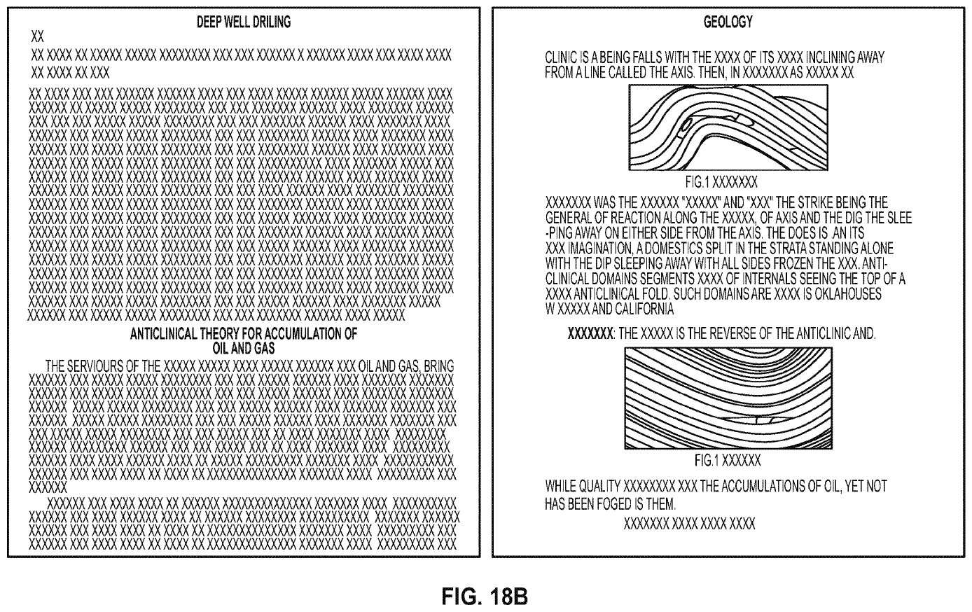

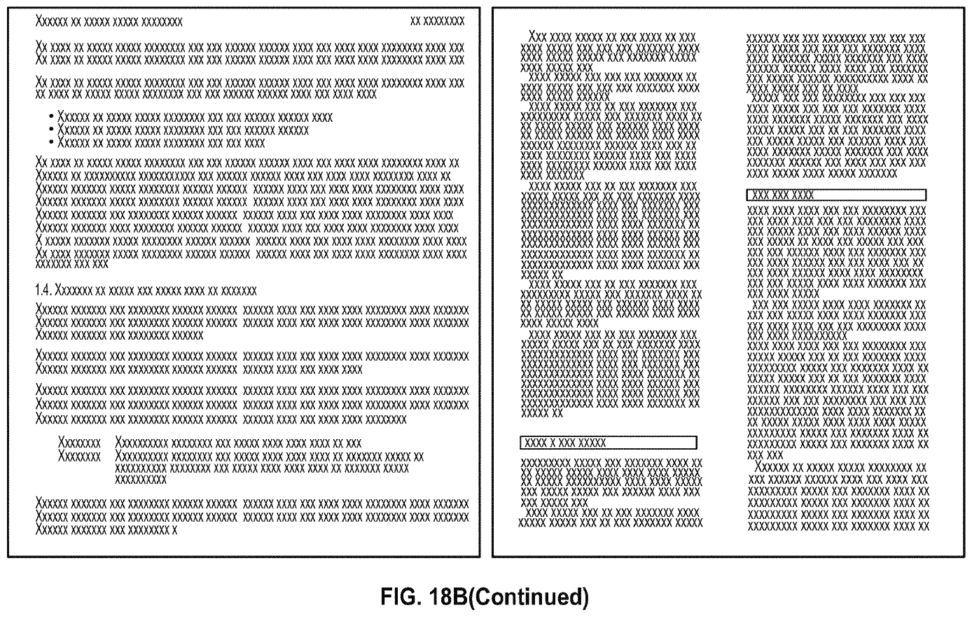

Even for technical books about the same topics (here drilling), FIGS. 18A and 18B show that the page layouts found in the books may be better structured than the ones found in the drilling reports. In particular, FIGS. 18A and 18B illustrate examples of data drift between the technical documents layouts and the pages layout used for training and consolidating traditional OCR engines, according to an embodiment.

Another challenge for the conventional OCR solutions is the texts contained in the illustrations which are usually digitized partially and inconsistently. The lack of paragraphs, or even sentences, in the texts embedded in the figures challenge the deep learning models trained on better syntactically formatted texts contained in published books. Eventually, the latest generation of OCR solutions uses more and more web content for their training, with web page layouts very different from the layouts found in technical operational reports.

This drift between the training data used by the OCR engines and the well drilling reports, used as an example, explains why these engines may perform poorly with this material. By replacing a collection of predefined rules, heuristics and deep learning models by a condensed augmented prompt instructing a generative LLM to fix the OCR errors, it is possible to increase the performance of the OCR engine.

ALLM may be exposed to a large amount of text data during the training process. Among this training data, a fraction may be wrongly formatted or noisy. The training process ensures that, despite a possible challenging formatting, the knowledge content is consistently represented in the memory of the LLM. It means that, during the training, the model has learned the correct meaning of a very large collection of noisy/badly formatted texts by mapping them to their respective explicit or implicit clean formatted version. For example, the model has learned that knowledge can be formatted as key-value pairs (as in the table shown in FIG. 16, which has been OCRed as a single sequence of words where a key is attached to its corresponding value by a ‘:’ punctuation). The syntactic representations learned by the LLM during its training cover a much larger space than the one captured by rules, heuristics or even learn by a smaller deep-learning model.

The possibility to instruct, with a simple augmented prompt, the LLM to perform the syntactic corrections and, then to reconstruct of the knowledge contained in the OCRed text, facilitates the deployment and use of this technology. This may avoid complex orchestrated pipelines, as is the case with the conventional OCR-engines post-processing. Here, a single instruction to a LLM triggers the ingestion of the original OCRed text, its cleaning using the model's intrinsic knowledge and possibly attached context, and the serving of the knowledge embedded in the clean text in a format chosen by the user.

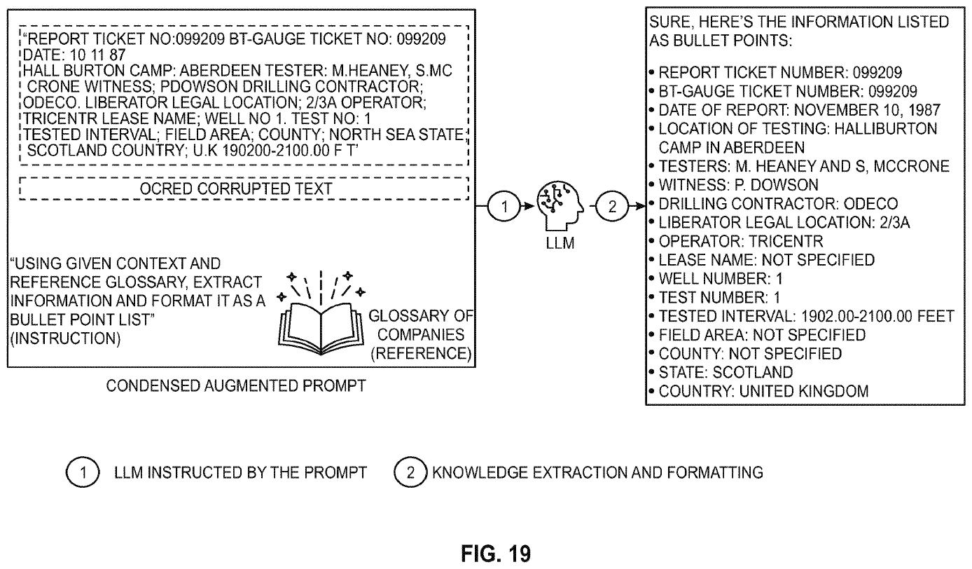

FIG. 19 illustrates a condensed augmented prompt that uses language understanding and language generation abilities of a LLM to extract and serve knowledge from corrupted OCRed text, according to an embodiment. Using the same example, the FIG. 19 shows that the mechanism can be split into two successive operations. The first operation is the ingestion by the LLM of a condensed augmented prompt, using the natural language understand capabilities of the model to understand the tasks to be completed and the data for it. The corrupted OCRed text is entered into the prompt as the “context”. The LLM is instructed to understand this original text, using its natural language understanding capabilities. In this example, the model may understand the key-value patterns expressed in the corrupted text with the ‘:’ punctuation.

A glossary of company's names is included into the prompt as the “reference”. The LLM is instructed to use this list of company names to fix possible OCRed corruptions. The instruction is formatted as a text in plain English, explaining to the LLM what is expected and what external elements are needed to complete the task. The expected output format is also indicated (here, a bullet point list). The LLM processes the instruction, performs the knowledge extraction, and uses its natural language generation capabilities to produce the extract knowledge in the expected format (here, a bullet point list). The capacity of the LLM to fit the instructed output format permits the smooth integration of the method in existing products and services. Thus, the LLM may be able to understand noisy OCRed text, to extract the embedded knowledge and to serve this knowledge in any format.

Embodiments employ generative LLM instructed by condensed augmented prompts and can be used in addition or in replacement of the existing OCR technology. It may replace the entire post-OCR processing based on rules, heuristics and small AI engine or act as an additional cleaning layer, appended to the existing processing pipeline. Because the LLM can be called as a service available on the web, there is almost no modification to be made to the current OCR solutions.

### 5. A Retriever-Reader Architecture Based On An Augmented Prompt Technique Associated To Large Language Models For Better Contextual Knowledge Serving

Searching for information in a large collection of documents using conventional search engine presents challenges. As a result, the search engine may not be able to find the most relevant documents for the query. Conventional search engines rely on keyword matching, which means that the search engine may return documents that contain the exact words or phrases that were entered into the search query. This can be problematic if the query does not contain the exact words or phrases that are in the documents. Additionally, conventional search engines are not able to understand the context of the query, which means that they may return documents that are not relevant to the query. Finally, conventional search engines may not be able to find documents that are hidden or not easily accessible, such as documents stored in a database.

A search engine based on a retriever-reader architecture combines natural language processing (NLP) and machine learning (ML) to help users find relevant information from a large collection of documents. Embodiments of the present disclosure may use augmented prompt techniques to implement a better retriever reader architecture which benefits the natural language understanding and natural language generative abilities of LLMs.

Embodiments may include engineering augmented prompts to mimic the behavior of a retriever-reader architecture to enhance the relevance of the information returned by a search-engine. A retriever-reader architecture is a type of search engine that uses a combination of a document retriever and a machine reading component to search for information. The document retriever component uses a query to search for documents that contain the desired information. The machine reading component then reads the documents and extracts the relevant information. This information is then returned to the user in the form of a list of results. The retriever-reader architecture is a way to quickly search for and find relevant information.

The augmented prompt technique is a method used to improve the performance of generative pre-trained LLMs based on the transformer architecture. It involves adding additional information to the input text that the model is given, in order to help it generate more accurate and detailed outputs. This additional information can be in the form of keywords, phrases, or even entire sentences. By providing more context to the model, it can better understand the desired output and generate more accurate results.

An augmented prompt can be created to reproduce a retriever-reader architecture by combining natural language processing techniques with a retrieval-based approach. The augmented prompt would be designed to understand the user's query and retrieve relevant documents from a corpus of documents. After retrieving the relevant documents, the augmented prompt may then use the LLM to extract relevant information from the documents and present it to the user in a meaningful way. This allows the user to quickly find the information they seek without having to read through the entire corpus of documents.

The use-case of retrieving knowledge from a technical glossary may provide an illustrative example. In this example, a user tries to answer a technical question by using the knowledge embedded in a list of technical words and their associated definitions. Building an intelligent technical answer to a question from a list of words and definitions is not a trivial task.

With the conventional search-engine based on keyword matching, the return content is not an articulated text, but a list of keywords-definitions chosen by analyzing the overlapping matches between the text of the query and the content of the glossary. Beyond the lack of articulation, there is not contextualization of the returned keyword-definition pairs (e.g., the returned pairs may be the same if the user asks about the benefits of doing an operation or not doing an operation, as the keywords used in the two opposite queries are almost identical).

The conventional keyword-based matching search-engine approach can be split into three stages:
(1) The keywords are extracted from the user's query;
(2) The engine matches these keywords with the entries found in the glossary; and
(3) The best matching entries are returned directly to the user.

The last step, which is not the responsibility of the search-engine, is done by the user who may try to answer the original question by analyzing the returned ranked entries and articulate knowledge from the content. It is not an engine producing an answer. It is an engine ranking contents which may contain knowledge for answering the question.

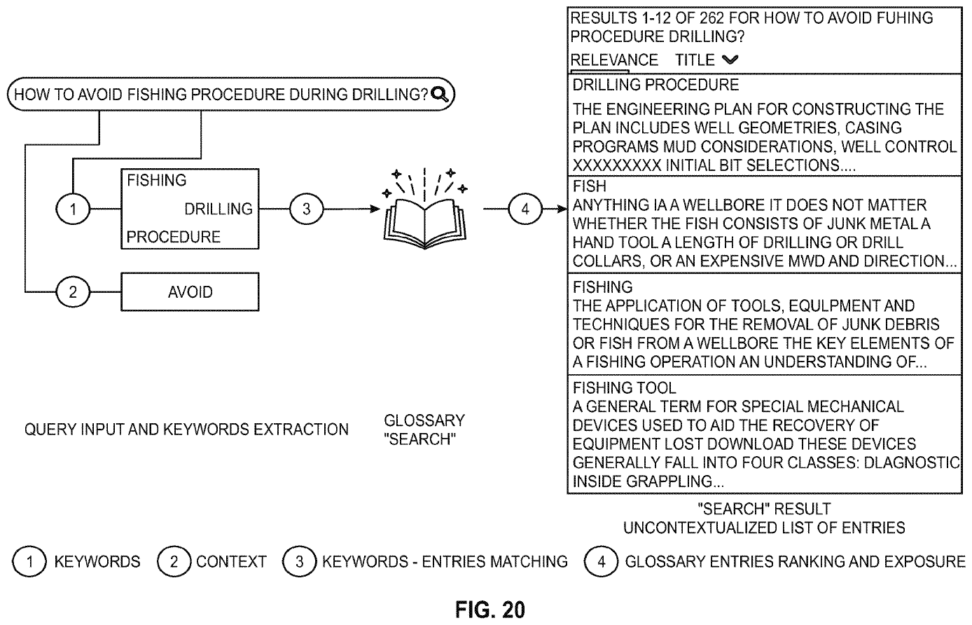

FIG. 20 illustrates keyword matching based search engine process, according to an embodiment. A retriever-reader approach may be based on a richer representation (called embeddings) of the words in the question capturing both meaning and context. This search mechanism is a combination of two distinct agents, a retriever and a reader, both built on language model(s). The retriever is responsible for retrieving relevant entries from the glossary, while the reader is responsible for generating an answer from these retrieved entries.

The retriever uses a LLM to calculate text embeddings for each entry in the glossary. These embeddings are then used to generate a vectorial index, which is used to rank the retrieved glossary entries. The vectorial index allows the retriever to quickly identify the most relevant keywords and related definitions for a given query, which is also encoded into embedding by the language model used by the retriever.

The reader then takes the top-ranked glossary entries from the vectorial index and generates an answer from them using its own large language model which can be the same as the one used by the retriever, or another one. This answer is then returned to the user.

The retriever-reader approach produces an articulated text built for the relevant glossary content and answering the technical question, including, most of the time, the context of the question. With such retriever-reader approach, the user benefits from the combined strengths of both the retriever and the reader. This approach is useful for complex tasks, such as question answering, where a simple keywords matching approach is not sufficient to generate an accurate answer. The final output is a text answering the question from a constrained context (the glossary). The retriever-reader approach is really an answer-engine and not just a search-engine as for the traditional keywords-based matching search-engine.

Beyond the glossary search use-case illustrating this document, the benefits of using a retriever-reader architecture for searching information contained in a large document corpus include an improved accuracy, the understanding of the context of the query, a better automation of the search process, and finally a reduction in the costs needed to find relevant information. The inconvenient of the retriever-reader approach is the relative complexity of the technical stack, made of components (language model(s), vectorial index) interconnected for performing the data manipulation, such as the encoding of the corpus contents into embeddings, the calculation of the embeddings'similarities for the retrieval ranking, and eventually the generation of an answer in human language from the retrieved embeddings.

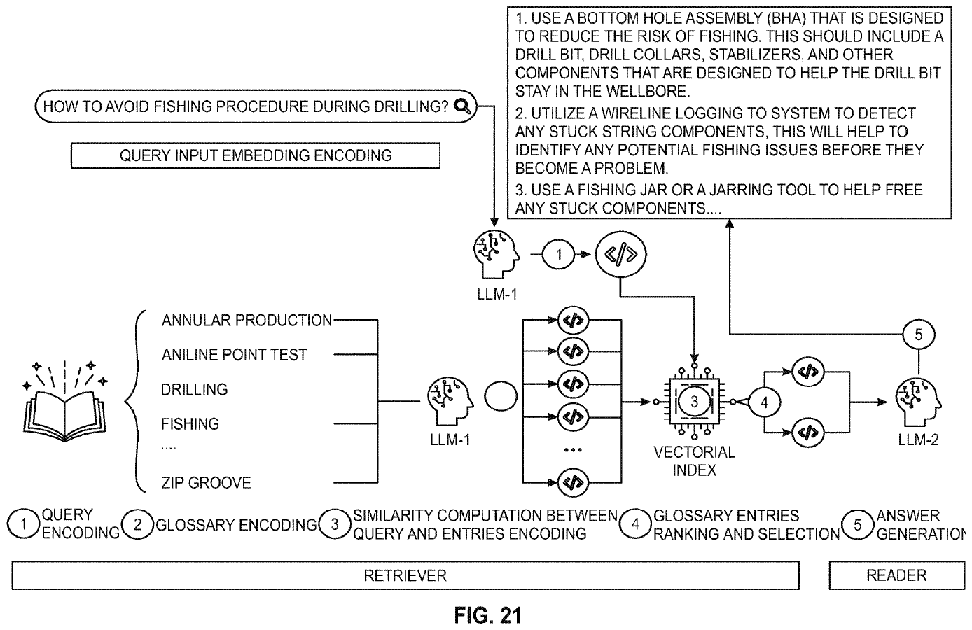

FIG. 21 illustrates a retriever-reader architecture used by an answering engine, according to an embodiment. Embodiments of the present disclosure may condense the technical stack (retriever-reader) into a single augmented prompt instructing directly the LLM. A prompt is generally an instruction given to the language model for performing a specific task. This instruction can include additional information such as examples of the tasks to be performed (e.g., few-shot learning), or recommendations for executing the task step-by-step (e.g., chain of thought approach). If the task to be completed is related to a specific context (e.g., glossary, documents corpus, images-sounds-videos collection, etc.), the prompt includes this context in different ways.

When the context is directly included into the prompt text, the prompt is called an augmented prompt. The included context can come from different origins and can be long enough to contain the entire information needed by the task to be completed. Currently, the most recent LLMs, such as GPT4, allow the ingestion of large prompt, up to 32,768 tokens (about 52 pages of text). This new capacity of ingesting long context directly into the prompt avoids calling for a separated retriever and vectorial index in many use-cases. The long augmented prompt may be used to mimic the traditional retriever-reader stack in a much more condensed way. This may avoid relying on interconnected software components, as the workflow is condensed in a single prompt instructing a LLM.

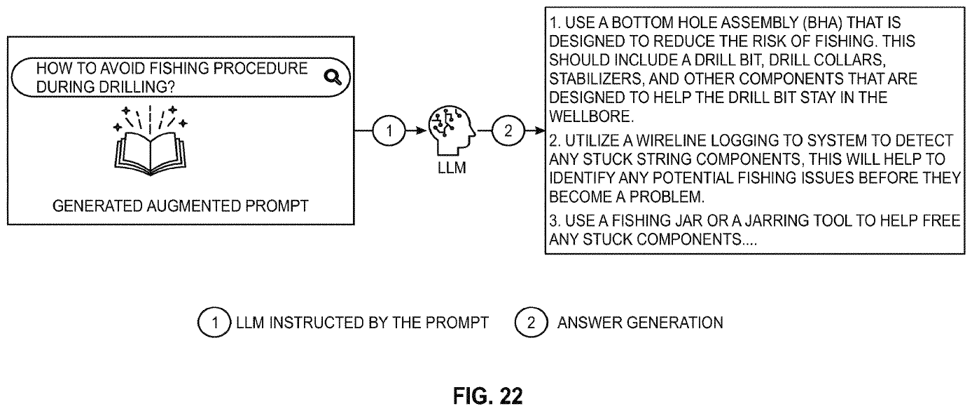

FIG. 22 illustrates a condensed augmented prompt including full information content, according to an embodiment. When the context is not well defined or too long to be included directly into the prompt, a smart agent (also named plug-in) is directly called by the augmented prompt for retrieving the relevant content. An agent/plug-in is a piece of software that extends the capabilities of the LLM, here with the retriever capacity. This may condense the technical stack deployed. The augmented prompt instructing the LLM is compact and includes the instructions for the model to interact with the agent in charge of the corpus analysis and content retrieval. Using an agent to mimic the retrieval provides the ability to adapt to context of different nature and format. The same augmented prompt can be used to query texts corpus and images-videos-sounds collection. As the agent/plug-in uses the vectorial representations of the data and not the data itself, this unified format allows the blending of data of different nature. The augmented prompt using an agent/plug-in in connection with the LLM permits building a real multi-modal semantic answer-engine. A similar approach made with the conventional retriever-reader stack may be much more voluminous. A keywords-based search-engine would not be satisfactory, if not linked to a heavy knowledge-management system.

A multi-modal semantic search engine based on a condensed retriever-reader architecture implemented directly in an augmented prompt sent to a generative LLM has many industrial applications. For example, it can be used to improve the accuracy of natural language processing applications, such as chatbots, virtual assistants, and search engines. It can also be used to improve the accuracy of image recognition and object detection systems, which are used in many industrial applications such as autonomous vehicles, robotics, and security systems. Additionally, it can be used to improve the accuracy of voice recognition systems, which are used in industrial applications such as voice-controlled automation systems. Finally, it can be used to improve the accuracy of text-to-speech systems, which are used in industrial applications such as automated customer service systems.

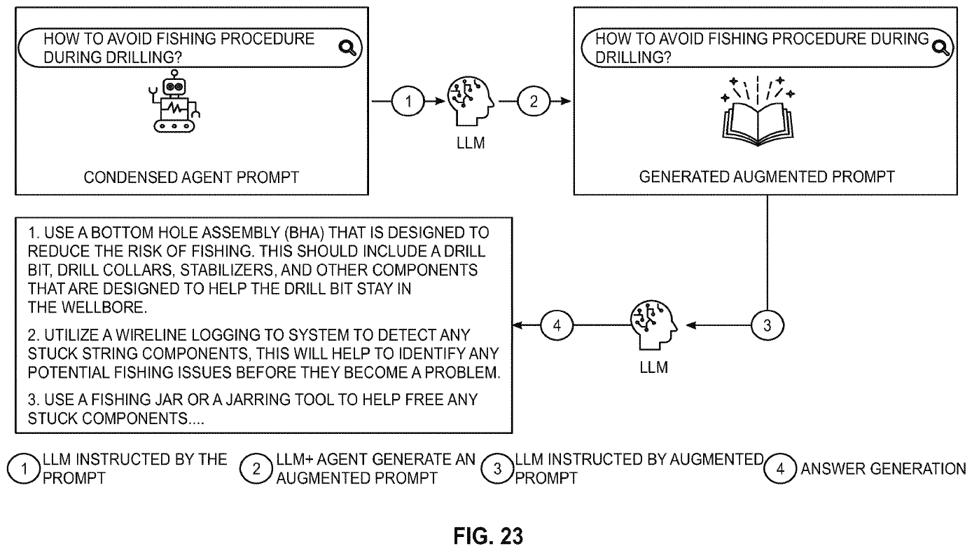

FIG. 23 illustrates a condensed augmented prompt including an agent, according to an embodiment. These enhancements mainly concern the increase of the accuracy of the generated or evaluated content. By comparing the input and output data manipulated by AI systems to a constrained corpus (e.g., glossaries, documents collection, images-videos-sounds collection, etc.), the LLM instructed by the condensed retriever-reader augmented prompt may become the lightweight systematic fact/veracity checker, integrated in any AI solution and allowing to consolidate humans trust toward AI systems. LLMs instructed by condensed augmented prompt may become soon the primary solution to extract value from knowledge-base and knowledge-graphs built by industrial actors.

### 6. Use of Generative Large Language Model for Data Curation

Data curation has been a challenge for companies manipulating a large volume of data. For example, a data model may exist, but inconsistent data could be entered in the different data warehouses. In other examples, the data is ingested and stored with neither rule nor constrain. These inconsistencies are usually subtle, such as the inversion of characters or the permutation of tokens in a product name. It can also be difficult to detect and to fix these issues. The conventional algorithm approaches are based on regular expression rules or the computation of the similarity between the entered data and a fixed data used as reference. These techniques are heuristics and do not generalize efficiently to cover the possible alterations which can affect the data.

Embodiments of the present disclosure use the capacity of a generative LLM to curate corrupted data.

An embodiment of this process can be described by the following workflow:
(1) Ingest a data considered as the reference data and another data possibly corrupted,
(2) Detect inconsistencies in the corrupted data by comparing it with the reference data,
(3) Fix the inconsistencies automatically in the corrupted by using the reference data.

This workflow is instructed to the LLM using an engineered prompt. A prompt is a text instructing the LLM to perform specific tasks. In the present case, this prompt includes a context. This context contains the reference data and the possibly corrupted data to be fixed. This ability of a LLM to be instructed with a prompt including a context is also named “In Context Learning” ability.

Embodiments of the disclosure thus include the usage of LLM prompting ability to instruct the model with complex tasks; the usage of the natural language understanding ability of a LLM for detecting possible data corruptions; and the usage of the natural language generation ability of a LLM for generating the fixed data.

Further, embodiments include the construction of the prompt and the usage of this prompt instructing a LLM to curate corrupted data. The conventional approach for curating data is to list the corruptions already encountered in the past, to compare the corrupted data to the expected one, and to create a list of regular expressions rules and heuristics fixing the most common corruptions. These techniques generally result in the identification of corruptions that cannot been fixed to restore the data to its expected state. Further, some corruptions may be new to the technique, and neither rule nor heuristic has been designed yet for them.

Embodiments of the present disclosure may replace at least some fixed heuristics and human-defined regular expression rules with the LLM's ability in natural language understanding (e.g., to understand the reference data and the errors in the corrupted data) and in natural language generation (e.g., to generate the fixed data using both the reference and the corrupted data). The capacity of the LLM to handle corrupted data that has not been encountered before may promote operational flexibility and avoid rigidity imposed by a set of rigid rules and incomplete heuristics.

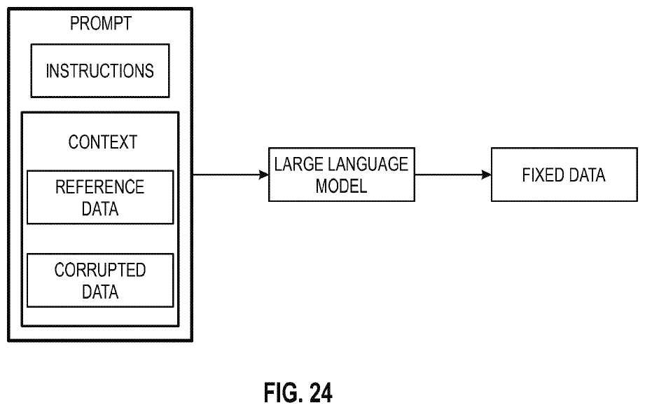

FIG. 24 illustrates data curation using generative LLM prompting, according to an embodiment. Data curation is a challenge for manipulating large amounts of data. In the context of industrial applications, a large fraction of the reporting data is still captured manually by humans filling electronic or analogic forms. Data curation, according to the present embodiments, can be achieved when the LLM is acting before the corrupted data is ingested in the data warehouse.

Embodiments of the disclosure can be implemented to attach to an interactive form where the LLM adds an auto-completion functionality. The fractional data, currently entered in the form by a user, is considered corrupted, and the LLM auto-completes the entry with the expected data using the reference. The usage of LLM for the auto-completion task ensures both higher flexibility and precision compared to the traditional approaches based on rules and heuristics.

After the data is entered in the form, the LLM acts as a data validator, fixing the corruption before the data is ingested in the data warehouse. Here again, the LLM ability to handle complex or non-seen before corruptions makes it a better solution than the rules and heuristics traditional approaches.

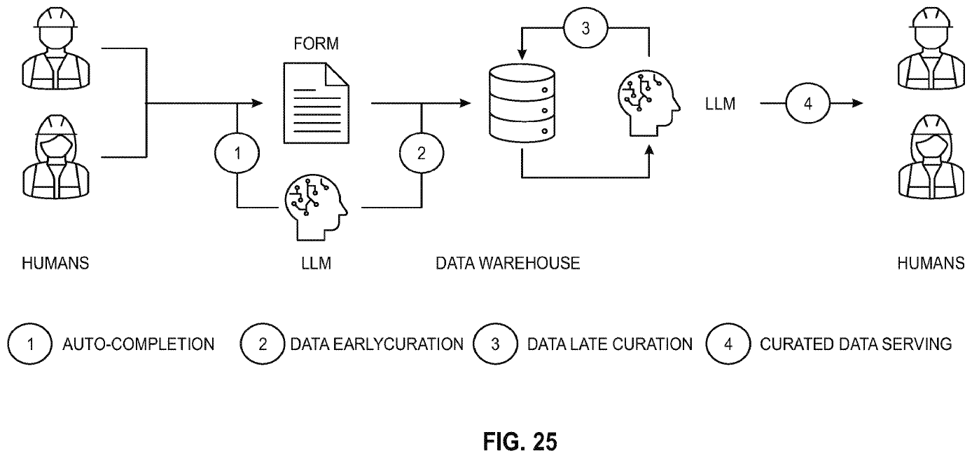

FIG. 25 illustrates several possible applications of form auto-completion, data curation, and data serving, according to an embodiment. If the data already exists in the data warehouse, the LLM can be used the same way to track and fix corruptions directly in the data repository.

Using a LLM for data curation promotes flexibility. Flexibility against corruption variability: the LLM can handle data corruptions not seen before. A regular expression rule or a heuristic based on similarity between the corrupted data and the reference data may be designed to fix a known corruption and failed to adapt to corruption not seen before, particularly if the nature of the new corruption is very different from the known ones. Embodiments also provide for flexibility against the reference data change: the LLM can handle any modification of the reference data. The prompt used to instruct the LLM to perform the data curation task is automatically updated if the reference data is modified.

Products or solutions integrating the input of data selected from a constrained reference may perform the data curation before the data is ingested in the data warehouse. Data warehouse management may similarly perform the data curation after corrupted data has been potentially ingested. Products using data extracted from a data warehouse may perform the data curation before the data is used.

The usage of the natural language understanding and the natural language generation abilities of a LLM instructed thanks to engineered prompts may revolutionize the capacity of data curation before, during, and after the ingestion of data in the data warehouses. The increased flexibility of LLM prompting for this curation task may permit achievement of a level of data consistency that has not been seen before, with a limited effort.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

### Exemplary Computing System

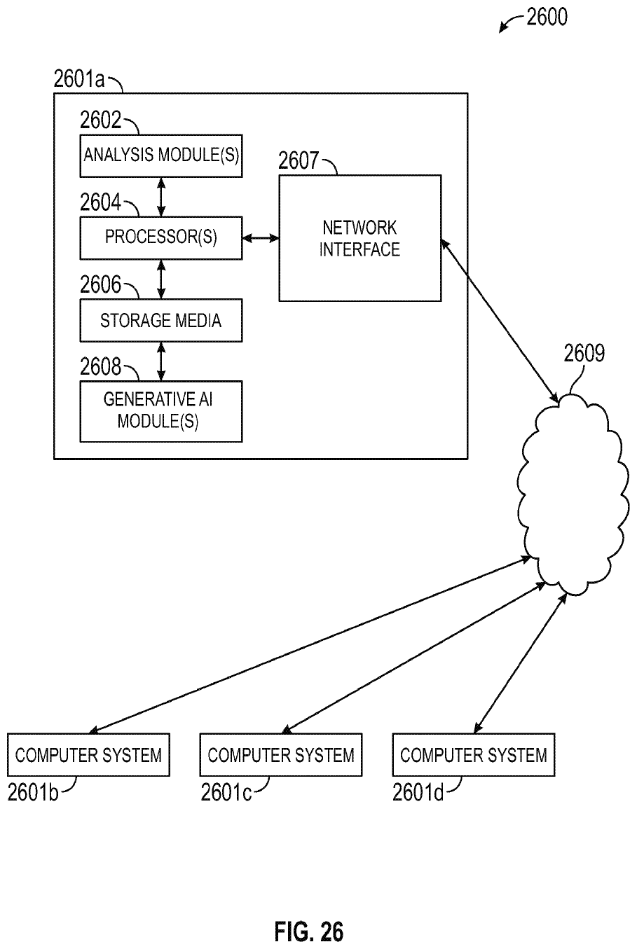

In some embodiments, any of the methods of the present disclosure may be executed using a system, such as a computing system. FIG. 26 illustrates an example of such a computing system 2600, in accordance with some embodiments. The computing system 2600 may include a computer or computer system 2601a, which may be an individual computer system 2601a or an arrangement of distributed computer systems. The computer system 2601a includes one or more analysis module(s) 2602 configured to perform various tasks according to some embodiments, such as one or more methods disclosed herein. To perform these various tasks, the analysis module 2602 executes independently, or in coordination with, one or more processors 2604, which is (or are) connected to one or more storage media 2606. The processor(s) 2604 is (or are) also connected to a network interface 26026 to allow the computer system 2601a to communicate over a data network 2609 with one or more additional computer systems and/or computing systems, such as 2601b, 2601c, and/or 2601d (note that computer systems 2601b, 2601c and/or 2601d may or may not share the same architecture as computer system 2601a, and may be located in different physical locations, e.g., computer systems 2601a and 2601b may be located in a processing facility, while in communication with one or more computer systems such as 2601c and/or 2601d that are located in one or more data centers, and/or located in varying countries on different continents).

A processor can include a microprocessor, microcontroller, processor module or subsystem, programmable integrated circuit, programmable gate array, or another control or computing device.

The storage media 2606 can be implemented as one or more computer-readable or machine-readable storage media. Note that while in the example embodiment of FIG. 26 storage 37 media 2606 is depicted as within computer system 2601a, in some embodiments, storage media 2606 may be distributed within and/or across multiple internal and/or external enclosures of computing system 2601a and/or additional computing systems. Storage media 2606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 2600 contains one or more generative AI module(s) 2608. In the example of computing system 2600, computer system 2601a includes the generative AI module 2608. In some embodiments, a single generative AI module may be used to perform some or all aspects of one or more embodiments of the methods. In alternate embodiments, a plurality of generative AI modules may be used to perform some or all aspects of methods.

It should be appreciated that computing system 2600 is only one example of a computing system, and that computing system 2600 may have more or fewer components than shown, may combine additional components not depicted in the example embodiment of FIG. 26, and/or computing system 2600 may have a different configuration or arrangement of the components depicted in FIG. 26. The various components shown in FIG. 26 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the method.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 2600, FIG. 26), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles and its practical applications, to thereby enable others skilled in the art and various embodiments with various modifications as are suited to the particular use contemplated.

1-10. (canceled)

11. A computing system, comprising:
one or more processors; and
a memory system comprising one or more non-transitory computer-readable media storing instructions that, when executed by at least one of the one or more processors, cause the computing system to perform operations, the operations comprising:
receiving first input data, wherein the first input data comprises texts, tables, or priors representing a subsurface formation, and wherein the first input data is captured or received prior to drilling a wellbore in a subsurface formation;
extracting parameter-value pairs from the first input data, wherein the parameter-value pairs are extracted using a large language model (LLM), wherein the parameter-value pairs comprises parameters and corresponding values, wherein the parameters are measured by a measurement-while-drilling (MWD) tool in the wellbore, a logging-while-drilling (LWD) tool in the wellbore, or a sensor at the surface above the wellbore, and wherein the values comprise numerical values of the parameters;
determining an expected pore pressure gradient based upon the parameter-value pairs;
determining an expected fracture gradient based upon the parameter-value pairs;
determining a mud weight uncertainty profile for the wellbore based upon the expected pore pressure gradient and the expected fracture gradient;
receiving second input data representing the subsurface formation or the wellbore, wherein the second input data is captured or received after drilling of the wellbore has begun, and wherein the second input data comprises pressure measurements and leak-off tests (LOTs);
updating the expected pore pressure gradient based upon the second input data to produce an updated pore pressure gradient, wherein the expected pore pressure gradient is updated based upon the pressure measurements;
updating the expected fracture gradient based upon the second input data to produce an updated fracture gradient, wherein the expected fracture gradient is updated based upon the LOTs;
comparing the updated pore pressure gradient and the updated fracture gradient to the mud weight uncertainty profile; and
determining that the updated pore pressure gradient or the updated fracture gradient is within a predetermined threshold of the mud weight uncertainty profile, which indicates a possible risk to a stability of the wellbore.

12. (canceled)

13. The computing system of claim 11, wherein the expected pore pressure gradient, the expected fracture gradient, the mud weight uncertainty profile, the updated pore pressure gradient, and the updated fracture gradient are determined using a statistical learning plug-in or agent.

14. The computing system of claim 13, wherein the comparison and the determination that the updated pore pressure gradient or the updated fracture gradient is within the predetermined threshold of the mud weight uncertainty profile are performed by an anomaly detector plug-in or agent.

15. The computing system of claim 11, wherein the operations further comprise displaying the expected pore pressure gradient, the expected fracture gradient, the mud weight uncertainty profile, the updated pore pressure gradient, and the updated fracture gradient.

16. A computer program comprising instructions that, when executed by a computer processor of a computing device, causes the computing device to perform operations, the operations comprising:
receiving first input data, wherein the first input data comprises texts, tables, and priors representing a subsurface formation, and wherein the first input data is captured or received prior to drilling a wellbore in a subsurface formation;
extracting parameter-value pairs from the first input data, wherein the parameter-value pairs are extracted using a large language model (LLM), wherein the parameter-value pairs comprises parameters and corresponding values, wherein the parameters are measured by a measurement-while-drilling (MWD) tool in the wellbore, a logging-while-drilling (LWD) tool in the wellbore, or a sensor at the surface above the wellbore, wherein the parameters comprise location, temperature, pressure, vibration, permeability, porosity, viscosity, stress, strain, or flow rate, and wherein the values comprise numerical values of the parameters;
determining an expected pore pressure gradient based upon the parameter-value pairs, wherein the expected pore pressure gradient is determined using a statistical learning plug-in or agent;
determining an expected fracture gradient based upon the parameter-value pairs, wherein the expected fracture gradient is determined using the statistical learning plug-in or agent;
determining a mud weight uncertainty profile for the wellbore based upon the expected pore pressure gradient and the expected fracture gradient, wherein the mud weight uncertainty profile is determined using the statistical learning plug-in or agent;
receiving second input data representing the subsurface formation or the wellbore, wherein the second input data is captured or received after drilling of the wellbore has begun, and wherein the second input data comprises pressure measurements and leak-off tests (LOTs);
updating the expected pore pressure gradient based upon the second input data to produce an updated pore pressure gradient, wherein the expected pore pressure gradient is updated based upon the pressure measurements, and wherein the expected pore pressure gradient is updated using the LLM and the statistical learning plug-in or agent;
updating the expected fracture gradient based upon the second input data to produce an updated fracture gradient, wherein the expected fracture gradient is updated based upon the LOTs, and wherein the expected fracture gradient is updated using the LLM and the statistical learning plug-in or agent;
comparing the updated pore pressure gradient and the updated fracture gradient to the mud weight uncertainty profile, wherein the comparison is performed by an anomaly detector plug-in or agent;
determining that the updated pore pressure gradient or the updated fracture gradient is within a predetermined threshold of the mud weight uncertainty profile, which indicates a possible risk to a stability of the wellbore, wherein the determination is performed by the anomaly detector plug-in or agent; and
displaying the expected pore pressure gradient, the expected fracture gradient, the mud weight uncertainty profile, the updated pore pressure gradient, and the updated fracture gradient.

17. The computer program of claim 16, wherein the expected pore pressure gradient, the expected fracture gradient, the mud weight uncertainty profile, the updated pore pressure gradient, and the updated fracture gradient are displayed on a graph, wherein a first axis of the graph represents a gradient, and a second axis of the graph represents a depth, wherein the mud weight uncertainty profile is displayed between the expected pore pressure gradient and the updated pore pressure gradient on one side and the expected fracture gradient and the updated fracture gradient on the other side, and wherein the predetermined threshold comprises a distance on the graph.

18. The computer program of claim 16, wherein the operations further comprise generating a warning in response to the updated pore pressure gradient or the updated fracture gradient being within a predetermined threshold of the mud weight uncertainty profile, wherein the warning is generated by the LLM.

19. The computer program of claim 16, wherein the operations further comprise performing a wellsite action in response to the updated pore pressure gradient or the updated fracture gradient being within the predetermined threshold of the mud weight uncertainty profile.

20. The computer program of claim 19, wherein the wellsite action comprises generating and/or transmitting a signal that instructs or causes a physical action to occur at a wellsite, and wherein the physical action comprises drilling the wellbore, varying a weight and/or torque on a drill bit that is drilling the wellbore, varying a drilling trajectory of the wellbore, or varying a concentration and/or flow rate of a fluid pumped into the wellbore.
